(19) United States
(12) Patent Application Publication
(10) Pub. No.: US 2015/0146537 A1
(43) Pub. Date: May 28, 2015

(54) COMMUNICATION SYSTEM

(71) Applicant: NEC Corporation, Tokyo (JP)

(72) Inventors: Dorin Panaitopol, Tokyo (JP); Abdoulaye Bagayoko, Tokyo (JP); Christian Mouton, Tokyo (JP); Thomas Delsol, Tokyo (JP)

(21) Appl. No.: 14/406,266

(22) PCT Filed: May 17, 2013
(86) PCT No.: PCT/JP2013/064543

§ 371 Date: Dec. 8, 2014

(30) Foreign Application Priority Data
Jun. 6, 2012 (GB) 1209953.7
Nov. 16, 2012 (GB) 1220696.7
Nov. 16, 2012 (GB) 1220697.5

(51) Int. Cl. H04W 28/02; H04W 8/00; H04W 72/08

(52) U.S. Cl. CPC H04W 28/0215; H04W 72/085; H04W 8/005; H04W 72/082; H04W 84/12
USPC 370/236

(57) ABSTRACT

A communication entity for a communication system (1) is described in which terminal devices (3) communicate with one another via a base station (5) using a radio access technology. The communication entity determines, for each terminal device, a respective characteristic value associated with communicating using at least one communication channel in at least one communication link between each terminal device and each other terminal device. The entity selects a terminal device to operate as an access node of a local area network based on the characteristic values.

### TECHNICAL FIELD

The present invention relates to mobile telecommunication networks, particularly but not exclusively networks operating according to the 3rd Generation Partnership Project (3GPP) standards or equivalents or derivatives thereof and wireless local area networks (WLANs). The invention has particular although not exclusive relevance to the configuration of a WLAN by entities in a cellular communication network.

### BACKGROUND ART

Under the 3GPP standards, a NodeB (or an eNB in LTE) is the base station via which mobile telephones connect to a core network and communicate to other mobile telephones or other such user equipment as part of a ‘mobile’ or ‘cellular’ communication network. For simplicity, the present application will use the term base station to refer to any such base station to refer to any similar communication device of a cellular communication system operating in accordance with any other technical standard.

The latest developments of the 3GPP standards are referred to as the Long Term Evolution (LTE) of EPC (Evolved Packet Core) network and E-UTRA (Evolved UMTS Terrestrial Radio Access) network.

In future releases of the 3GPP standards, there are plans to introduce a feature of so called ‘device-to-device’ (D2D) radio communication when a terminal device can communicate user data to another terminal device that is within the transmission range of the first terminal device without having to route the user data via the wider cellular communication network. This direct radio communication would result in better utilization of the network resources without sacrificing the service quality to the end user. Although a direct E-UTRAN channel could potentially be set-up between mobile telephones, or other such terminal devices, which are located in sufficiently close proximity to one another, such communication would still require 3GPP radio resources for the D2D communication.

A local network (e.g. a WLAN) of appropriately equipped terminal devices may be available using, for example, WiFi technology which may allow direct device-to-device communication between the user devices, using the resources of the local area network rather than the resources of the wider cellular communication that might otherwise be required. Thus pressure on the limited resources of the wider cellular communication network can be further alleviated.

A local network may be formed for example to avoid core network congestion. Such local network is built from a number of stations—‘STA’ (or ‘STAtions’—in the context of a local area network) communicating via an access point (‘AP’). The access point used for such a local area network is defined by construction and has different capabilities to a STA. In order to set-up the network, the access point selects a channel for communication with the stations, based on direct measurements of transmitted signal quality (e.g. received signal power, interference, bit error rate (BER), lost packets, etc.).

### SUMMARY OF INVENTION

### Technical Problem

In current configurations, however, the local network has a limited communication capacity and the measurement, analysis and decision making associated with channel selection can be time consuming and can thus cause delays in the set-up of a local area network. This has the potential to have a knock on effect for the wider cellular network with resources being released later and an associated delay in the alleviation of congestion. Furthermore the current approach can lead to a communication channel being selected that is non-optimum.

Accordingly, preferred embodiments of the present invention aim to provide methods and apparatus which overcome or at least alleviate one or more of the above issues.

Although for efficiency of understanding for those of skill in the art, the invention will be described in detail in the context of a 3GPP technology (UMTS, LTE) and a WLAN operating using an IEEE 802.11 technology (commonly called WiFi), the principles of the invention can be applied to other systems in which terminal devices (e.g. User Equipment (UE)/stations (STA)) such as mobile telephones can communicate directly with each other, while being connected to a core network, using multiple radio access technologies or access to a local area network.

### Solution to Problem

According to one aspect of the present invention, there is provided a communication entity for a communication system in which terminal devices communicate with one another via a base station using a radio access technology. The communication entity comprises means for identifying a plurality of said terminal devices for forming a potential local area network (LAN) of said terminal devices; means for determining, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN; means for selecting a terminal device to operate as an access node of said local area network based on said characteristic values so determined; and means for communicating with at least one of said plurality of terminal devices to identify which of said plurality of terminal devices has been selected to operate as an access node and/or which of said plurality of terminal devices has not been selected to operate as an access node.

In one possibility there are provided a plurality of potential communication channels for communicating in the at least one communication link between each said terminal device and each other of said plurality of terminal devices; and said selecting means is operable to select a communication channel to use for communication in said LAN based on said at least one characteristic value determined by said determining means; and said communicating means is operable to communicate with at least one of said plurality of communication devices to identify said selected communication channel.

The selecting means may identify, for each of said plurality of terminal devices, a respective lowest quality communication link, between that terminal device and each other of said plurality of terminal devices, wherein the lowest quality link exhibits the lowest determined characteristic value from amongst the characteristic values determined for all the communication channels on all the communication links for that terminal; and select a terminal device to operate as an access node and/or a communication channel to use for communication in said LAN so as to maximise the potential quality of service for communications using said lowest quality communication link.

The selecting means may identify, for each of said plurality of terminal devices, a respective lowest quality communication link, between said terminal device and each other of said plurality of terminal devices, wherein the lowest quality link exhibits the lowest determined characteristic value from amongst the characteristic values determined for all the communication channels on all the communication links for that terminal; and select a terminal device to operate as an access node and/or a communication channel to use for communication in said LAN based on the lowest quality communication links so identified.

The selecting means may identify, for each of said plurality of terminal devices, a communication channel exhibiting the highest determined characteristic value from amongst the communication channels on the lowest quality communication link identified for that terminal device; and select a terminal device to operate as an access node and/or a communication channel to use for communication in said LAN based on said communication channels, from amongst the communication channels on the lowest quality communication links, found to exhibit the highest determined characteristic values.

The selecting means may also identify, from amongst said communication channels found to exhibit the highest determined characteristic values for the lowest quality communication links, the communication channel having the highest overall determined characteristic value; select, as the terminal device to operate as an access node in said LAN, the terminal device associated with communication channel having the highest overall determined characteristic value; and/or select, as the communication channel to use for communication in said LAN, the communication channel having the highest overall determined characteristic value.

The selecting means may identify, based on said determined characteristic values, a lowest communication quality terminal device, wherein the lowest communication quality terminal device exhibits the lowest characteristic value from amongst the characteristic values determined for the communication channels and the communication links for the plurality of terminal devices; and select a terminal device to operate as an access node and/or a communication channel to use for communication in said LAN so as to maximise the potential quality of service, for communications with said lowest communication quality terminal device.

The selecting means may identify, based on said determined characteristic values, a highest communication quality terminal device, wherein the highest communication quality terminal device exhibits the highest characteristic value from amongst the characteristic values determined for the communication channels and the communication links for the plurality of terminal devices; and select a terminal device to operate as an access node and/or a communication channel to use for communication in said LAN so as to maximise the potential quality of service for communications with said highest communication quality terminal device.

The selecting means may select a terminal device to operate as an access node and/or a communication channel to use for communication in said LAN so as to maximise the sum of said characteristic values for all said communication links between each said terminal device and each other of said plurality of terminal devices.

The selecting means may select a terminal device to operate as an access node and/or a communication channel to use for communication in said LAN so as to minimise the communication link to communication link variation in characteristic values for said communication links between each said terminal device and each other of said plurality of terminal devices.

The selecting means may determine said characteristic value based on at least one equation or algorithm represented in memory of said entity.

The selecting means may determine said characteristic value based on the following equation:

$$C ( i , j , ch ) = {log}_{2} ( 1 + \frac{{P}_{i} \times {d}_{i , j}^{- α} \times {H}_{i , j} \times {G}_{i , j}}{{I}_{j , ch} + {n}_{i , ch}} ) , \\ for i , j = 1 , … , N and ch = 1 , … , M \qquad [ Math . 1 ]$$

where: C(i, j, ch) is an absolute characteristic value that is representative of the quality of service in a communication link from a terminal device indexed i, to a terminal device indexed j, in a channel indexed ch; Pᵢ is a transmit power attributed to the terminal device i; d_{i,j} is the distance between terminal device i and terminal device j; α is an exponent to take account of path loss for the link between terminal device i and terminal device j; G_{i,j} is a gain value based on the antenna gain of both terminal device i and terminal device j; I_{j,ch} is a measure of the interference at the terminal device j in communication channel ch; H_{i,j} represents the mean gain of the communication channel between transmitter i and receiver j; n_{j,ch} is a measure of the Gaussian noise at the terminal device j in communication channel ch; M is the number of channels; N is the number of terminal devices in the potential LAN.

The characteristic value may be said absolute characteristic value.

The selecting means may determine said characteristic value further based on the following equation:

Δ(_{i,j,ch})=C(i,j,ch)−C₀(j) [Math. 2]

where: C(i, j, ch) is the absolute characteristic value that is representative of the quality of service in the communication link from the terminal device indexed i, to the terminal device indexed j, in the channel indexed ch; Δ(_{i,j,ch}) is a relative characteristic value that is representative of the quality of service, relative to a target quality of service, for the communication link from the terminal device indexed i, to a terminal device indexed j, in a channel indexed ch; and C₀(j) is a target characteristic value that is representative of a target quality of service in a communication link.

The determining means may determine said characteristic values based on a transmitter power; wherein said selecting means may check if the determined characteristic values indicate that the quality of service represented by the determined characteristic values meets a required quality of service; wherein if the quality of service represented by the determined characteristic values does not meet the required quality of service, said determining means may recalculate said characteristic values based on an increased transmitter power.

The recalculation of said characteristic values may be repeated, based on increasing transmitter powers, until the quality of service represented by the determined characteristic values meets the required quality of service or a maximum transmitter power is reached.

The communication entity may further comprise means for receiving the results of measurements, from each said terminal device, wherein said results represent at least one of measured interference and measured noise in a communication channel on a communication link between the terminal device from which the measurement results are received and at least one other of said terminal devices, and wherein said determining means is operable to determine said characteristic value based on said measurement results.

The communication entity may further comprise means for receiving localisation information from at least one further communication entity (e.g. a Mobility Management Entity (MME)), wherein said determining means is operable to determine said characteristic value based on said localisation information.

The communication entity may further comprise means for receiving information identifying terminal device specific parameters (e.g. an antenna gain) from at least one further communication entity (e.g. a Mobility Management Entity (MME)), wherein said determining means is operable to determine said characteristic value based on said terminal device specific parameters.

The LAN may be a wireless LAN (WLAN) and may be operating in accordance with IEEE 802.11 standards (or a derivative thereof). Alternatively, the WLAN may be operating in accordance with IEEE 802.15 (also known as ‘Bluetooth’) standards (or a derivative thereof).

The radio access technology may be a radio access technology in accordance with 3rd Generation Partnership Project (3GPP) technical standards (or a derivative thereof). Preferably, the radio access technology may be a radio access technology in accordance with long term evolution (LTE) 3GPP technical standards (or a derivative thereof—such as an LTE-Advanced 3GPP technical standard).

The invention also provides a terminal device for a communication system in which terminal devices communicate with one another via a base station using a radio access technology, the terminal device comprising: means for receiving, from a communication entity of the communication system, information identifying that said terminal device has been selected to operate as an access node of a local area network (LAN) of said terminal devices; means for communicating with the communication entity, and other terminal devices, to form a LAN of terminal devices in which said terminal device is the access node.

The terminal device may further comprise means for providing the results of measurements, to the communication entity, wherein said results represent at least one of measured interference and measured noise in a communication channel on a communication link between the terminal device from which the measurement results are received and at least one other of said terminal devices, and wherein said information identifying that the terminal device has been selected to operate as an access node is provided by said communication entity based on said results of measurements.

The invention also provides a method performed by a communication entity of a communication system in which terminal devices communicate with one another via a base station using a radio access technology, the method comprising: identifying a plurality of said terminal devices for forming a potential local area network (LAN) of said terminal devices; determining, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN; selecting a terminal device to operate as an access node of said local area network based on said characteristic values so determined; and communicating with at least one of said plurality of terminal devices to identify which of said plurality of terminal devices has been selected to operate as an access node and/or which of said plurality of terminal devices has not been selected to operate as an access node.

The invention also provides a method performed by a terminal device of a communication system in which terminal devices communicate with one another via a base station using a radio access technology, the method comprising: receiving, from a communication entity of the communication system, information identifying that the terminal device has been selected to operate as an access node of a local area network (LAN) of said terminal devices; means for communicating with the communication entity, and other terminal devices, to form a LAN of terminal devices in which said terminal device is the access node.

The invention also provides a communication entity for a communication system in which terminal devices communicate with one another via a base station using a radio access technology, the communication entity comprising a processor operable to: identify a plurality of said terminal devices for forming a potential local area network (LAN) of said terminal devices; determine, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN; and select a terminal device to operate as an access node of said local area network based on said characteristic values so determined; and a transceiver operable to communicate with at least one of said plurality of terminal devices to identify which of said plurality of terminal devices has been selected to operate as an access node and/or which of said plurality of terminal devices has not been selected to operate as an access node.

The invention also provides a terminal device for a communication system in which terminal devices communicate with one another via a base station using a radio access technology, the terminal device comprising: a transceiver operable to receive, from a communication entity of the communication system, information identifying that said terminal device has been selected to operate as an access node of a local area network (LAN) of said terminal devices; and to communicate with the communication entity, and other terminal devices, to form a LAN of terminal devices in which said terminal device is the access node.

According to a yet further aspect of the present invention, there is provided a communication entity for a communication system in which terminal devices communicate with one another via a base station using a radio access technology, the communication entity comprising: means for identifying a plurality of said terminal devices for forming a potential local area network (LAN) of said terminal devices having at least one of said terminal devices operating as an access point via which each of the other terminal devices can communicate respectively using at least one communication channel in at least one of a plurality of communication links; means for determining for a given terminal device of said plurality of terminal devices, a characteristic value associated with communicating using each communication channel in each communication link between the given terminal device and another terminal device of said plurality of terminal devices, wherein said characteristic value is representative of a potential quality of service that will be provided by the first communication channel as part of said potential LAN; wherein said determining means is operable:

(a) to determine for a first given communication channel and a first given terminal device whether every such characteristic value for every communication link between the first given terminal device and each other terminal device, meets an associated requirement;

(b) if, for the first given communication channel and the first given terminal device, every said characteristic value for every communication link between the first given terminal device and each other terminal device meets the associated requirement, to identify the first given terminal device to be a potential access point;

(c) if, for the first given communication channel and the first given terminal device, any said characteristic value for any communication link between the first given terminal device and each other terminal device does not meet the associated requirement, to not identify the first given terminal device to be a potential access point.

The communication entity comprises means for selecting a terminal device, to operate as an access node of said local area network, that has been identified as a potential access point by the determining means; and means for communicating with at least one of said plurality of terminal devices to identify which of said plurality of terminal devices has been selected to operate as an access node and/or which of said plurality of terminal devices has not been selected to operate as an access node.

In one possibility there are provided a plurality of potential communication channels for communicating in each communication link between each said terminal device and each other of said plurality of terminal devices; and said determining means may: if, for the first given communication channel and the first given terminal device, every said characteristic value for every communication link between the first given terminal device and each other terminal device meets the associated requirement, identify the first given communication channel to be a potential communication channel to use for communication in said LAN; and said selecting means may select a communication channel to use for communication in said LAN that has been identified as a potential communication channel by the determining means; and said communicating means may communicate with at least one of said plurality of communication devices to identify said selected communication channel.

In one possibility, said determining means may determine said characteristic value from at least one parameter, the at least one parameter comprising at least one of: an error rate; a bit rate; a bit error rate; a packet error rate; a maximum length of a packet (e.g. maximum number of bits contained in a packet); a value of energy per bit; a noise power spectral density; a bandwidth; transmit power attributed for the given terminal device; distance between the given terminal device and the other terminal device; a path loss parameter for the link between the given terminal device and the other terminal device; a gain value based on the antenna gain of at least one of the given terminal device and the other terminal device; a measure of the interference at the other terminal device in the given communication channel; and a measure of the Gaussian noise at the other terminal device in the communication channel.

In one possibility, the characteristic value determined by said determining means may be a signal to noise ratio (for example, a signal to interference plus noise ratio) and said associated requirement is a target signal to noise ratio. In this case, the signal to noise ratio is calculated based on the following equation:

$$SINR ( i , j , chn ) = \frac{{P}_{Tx} ( i , j ) \times {G}_{i , j} \times {H}_{i , j} \times {d}_{i , j}^{- α}}{{N}_{0} \times W + I ( j , chn )} . \qquad [ Math . 3 ]$$

where P_{Tx}(i, j) is an initial transmission power of transmitting terminal device i to receiving terminal device j; I(j,chn) is the interference level in channel chn measured at receiver j; d_{i,j} is the distance between terminal device i and terminal device j; α is an exponent to take account of path loss for the link between terminal device i and terminal device j; G_{i,j} is a gain value based on the antenna gain of both terminal device i and terminal device j; H_{i,j} represents the mean gain of the communication channel between transmitter i and receiver j; N₀ is the noise power spectral density; and W is the bandwidth.

The target signal to noise ratio may be calculated based on the following equation:

$${SNR}_{req} = \frac{{R}_{b}}{W} \times \frac{{E}_{b}}{{N}_{0}} \qquad [ Math . 4 ]$$

where R_{b} is a bit rate; E_{b} is an energy per bit; N₀ is the noise power spectral density; and W is the bandwidth.

The target signal to noise ratio may be calculated based on information derived from a characteristic of bit error rate (BER) versus E_{b}/N₀, where E_{b} is the energy per bit, and N₀ is the noise power spectral density. In this case, the target signal to noise ratio may be calculated based on a value of E_{b}/N₀ for a given BER on said on information derived from a curve of bit error rate (BER) versus E_{b}/N₀.

The bit error rate (BER) may be calculated based on the following equation:

$$BER = 1 - {( 1 - PER )}^{\frac{1}{{L}_{max}}} \qquad [ Math . 5 ]$$

where Lₘₐₓ is a maximum length of the packet (e.g. maximum number of bits contained in a packet) and PER is a packet error rate (PER) derived for a desired service. In this case, the PER may be derived for a given quality of service class identifier (QCI) for the desired service. For example, the PER may be derived from a lookup table.

In one possibility, the communication entity may further comprise means for receiving the results of measurements, from each said terminal device, wherein said results represent at least one of measured interference and measured noise in a communication channel on a communication link between the terminal device from which the measurement results are received and at least one other of said terminal devices, and wherein said determining means is operable to determine said characteristic value based on said measurement results.

In one possibility, the communication entity may further comprise means for receiving localisation information from at least one further communication entity (e.g. a Mobility Management Entity (MME)), wherein said determining means is operable to determine said characteristic value based on said localisation information.

In one possibility, the communication entity may further comprise means for receiving information identifying terminal device specific parameters (e.g. an antenna gain) from at least one further communication entity (e.g. a Mobility Management Entity (MME)), wherein said determining means is operable to determine said characteristic value based on said terminal device specific parameters.

The LAN may be a wireless LAN (WLAN). For example, the WLAN may be a WLAN operating in accordance with IEEE 802.11 standards (or a derivative thereof). Alternatively, the WLAN may be a WLAN operating in accordance with IEEE 802.15 (also known as ‘Bluetooth’) standards (or a derivative thereof).

In one possibility, the communication entity may be a WLAN manager.

The radio access technology may be a radio access technology in accordance with 3rd Generation Partnership Project (3GPP) technical standards (or a derivative thereof). In this case, the radio access technology may be a radio access technology in accordance with long term evolution (LTE) 3GPP technical standards (or a derivative thereof—such as an LTE-Advanced 3GPP technical standard).

According to another aspect of the present invention, there is provided a terminal device for a communication system in which terminal devices communicate with one another via a base station using a radio access technology, the terminal device comprising: means for receiving, from a communication entity of the communication system, information identifying that said terminal device has been selected to operate as an access node of a local area network (LAN) of said terminal devices; and means for communicating with the communication entity, and other terminal devices, to form a LAN of terminal devices in which said terminal device is the access node.

In one possibility, the communication means may be operable to communicate, in said LAN, using a communication channel in at least one communication link having a signal to noise ratio that has been determined to meet a target signal to noise ratio by said communication entity.

In one possibility, the terminal device may further comprise means for providing the results of measurements, to the communication entity, wherein said results represent at least one of measured interference and measured noise in a communication channel on a communication link between the terminal device from which the measurement results are received and at least one other of said terminal devices, and wherein said information identifying that the terminal device has been selected to operate as an access node is provided by said communication entity based on said results of measurements.

In one possibility, the terminal device may comprise at least one of a mobile telephone and a portable computer device.

According to yet another aspect of the present invention, there is provided a method performed by a communication entity for a communication system in which terminal devices communicate with one another via a base station using a radio access technology, wherein said communication entity is operable to determine for a given terminal device, a characteristic value associated with communicating using at least one communication channel in a communication link between the given terminal device and another terminal device, wherein said characteristic value is representative of a potential quality of service that will be provided by the first communication channel as part of said potential LAN, the method comprising: identifying a plurality of said terminal devices for forming a potential local area network (LAN) of said terminal devices having at least one of said terminal devices operating as an access point via which each of the other terminal devices can communicate respectively using at least one communication channel in at least one of a plurality of communication links; determining for a first given communication channel and a first given terminal device whether every such characteristic value for every communication link between the first given terminal device and each other terminal device, meets an associated requirement; based on said determining:

(a) if, for the first given communication channel and the first given terminal device, every said characteristic value for every communication link between the first given terminal device and each other terminal device meets the associated requirement, identifying the first given terminal device to be a potential access point; and

(b) if, for the first given communication channel and the first given terminal device, any said characteristic value for any communication link between the first given terminal device and each other terminal device does not meet the associated requirement, not identifying the first given terminal device to be a potential access point;

The method comprises selecting a terminal device, to operate as an access node of said local area network, that has been identified as a potential access point by the determining step; and communicating with at least one of said plurality of terminal devices to identify which of said plurality of terminal devices has been selected to operate as an access node and/or which of said plurality of terminal devices has not been selected to operate as an access node.

In one possibility, there are provided a plurality of potential communication channels for communicating in each communication link between each said terminal device and each other of said plurality of terminal devices; and said determining step may: if, for the first given communication channel and the first given terminal device, every said characteristic value for every communication link between the first given terminal device and each other terminal device meets the associated requirement, identify the first given communication channel to be a potential communication channel to use for communication in said LAN; said selecting step may select a communication channel to use for communication in said LAN that has been identified as a potential communication channel by the determining step; and said communicating step may communicate with at least one of said plurality of communication devices to identify said selected communication channel.

The invention also provides a method performed by a terminal device for a communication system in which terminal devices communicate with one another via a base station using a radio access technology, the method comprising: receiving, from a communication entity of the communication system, information identifying that said terminal device has been selected to operate as an access node of a local area network (LAN) of said terminal devices; and communicating with the communication entity, and other terminal devices, to form a LAN of terminal devices in which said terminal device is the access node.

In this case, the communication step may comprise communicating, in said LAN, using a communication channel in at least one communication link having a signal to noise ratio that has been determined to meet a target signal to noise ratio by said communication entity.

According to another aspect of the present invention, there is provided a communication entity for a communication system in which terminal devices communicate with one another via a base station using a radio access technology, the communication entity comprising: means for identifying a plurality of said terminal devices for forming a potential local area network (LAN) of said terminal devices; means for determining, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN. The determining means is further operable: to determine, for each terminal device, and each communication channel, a minimum transmit power required to ensure that said characteristic value meets an associated requirement for each communication link between that terminal device and each other terminal device. The communication entity comprises means for selecting a terminal device to operate as an access node of said local area network based on said determined minimum transmit powers for said terminal devices and said channels; and means for communicating with at least one of said plurality of terminal devices to identify which of said plurality of terminal devices has been selected to operate as an access node and/or which of said plurality of terminal devices has not been selected to operate as an access node.

In one possibility, the determining means may be further operable to identify, for all communication links, for each terminal device and each communication channel, a power value representing a highest of said determined minimum transmit powers for that terminal device and communication channel; and said selecting means may be operable to select said terminal device to operate as said access node of said local area network based on said determined power values for said terminal devices and said channels.

In one possibility, the determining means may be further operable to identify for each terminal device, the channel exhibiting the lowest of said identified power values; and the selecting means may be operable to select, as said terminal device to operate as said access node of said local area network, the terminal device for which the identified channel exhibiting the lowest of said identified power values exhibits said lowest of said identified power values.

In one possibility, the selecting means may be operable to select, as a communication channel to use for communication in said LAN, said channel exhibiting the lowest of said identified power values; and wherein said communicating means may be operable to communicate with at least one of the terminal devices to identify said selected communication channel.

In one possibility, the determining means may be operable to determine said characteristic value from at least one parameter, the at least one parameter comprising at least one of: an error rate; a bit rate; a bit error rate; a packet error rate: a maximum length of a packet (e.g. maximum number of bits contained in a packet); a value of energy per bit; a noise power spectral density; a bandwidth; transmit power attributed for the given terminal device; distance between the given terminal device and the other terminal device; a path loss parameter for the link between the given terminal device and the other terminal device; a gain value based on the antenna gain of at least one of the given terminal device and the other terminal device; a measure of the interference at the other terminal device in the given communication channel; and a measure of the Gaussian noise at the other terminal device in the communication channel.

In one possibility, the characteristic value determined by said determining means may be a signal to noise ratio (for example, a signal to interference plus noise ratio) and said associated requirement is a target signal to noise ratio. In this case, the signal to noise ratio may be calculated based on the following equation:

$$SINR ( i , j , chn ) = \frac{{P}_{Tx} ( i , j ) \times {G}_{i , j} \times {H}_{i , j} \times {d}_{i , j}^{- α}}{{N}_{0} \times W + I ( j , chn )} \qquad [ Math . 6 ]$$

where: P_{Tx}(i, j) is an initial transmission power of transmitting terminal device i to receiving terminal device j; I(j,chn) is the interference level in channel chn measured at receiver j; d_{i,j} is the distance between terminal device i and terminal device j; α is an exponent to take account of path loss for the link between terminal device i and terminal device j; G_{i,j} is a gain value based on the antenna gain of both terminal device i and terminal device j; H_{i,j} is a mean channel gain value associated with a channel between terminal device i and terminal device j: N₀ is the noise power spectral density; and W is the bandwidth.

In one possibility, the target signal to noise ratio may be calculated based on the following equation:

$${SNR}_{req} = \frac{{R}_{b}}{W} \times \frac{{E}_{b}}{{N}_{0}} \qquad [ Math . 7 ]$$

where R_{b} is a bit rate; E_{b} is an energy per bit; N₀ is the noise power spectral density; and W is the bandwidth.

In one possibility, the target signal to noise ratio may be calculated based on information derived from a characteristic of bit error rate (BER) versus E_{b}/N₀, where E_{b} is the energy per bit, and N₀ is the noise power spectral density. In this case, the target signal to noise ratio may be calculated based on a value of E_{b}/N₀ for a given BER on said on information derived from a curve of bit error rate (BER) versus E_{b}/N₀.

In one possibility, the bit error rate (BER) may be calculated based on the following equation:

$$BER = 1 - {( 1 - PER )}^{\frac{1}{{L}_{max}}} \qquad [ Math . 8 ]$$

where Lₘₐₓ is a maximum length of the packet (e.g. maximum number of bits contained in a packet) and PER is a packet error rate (PER) derived for a desired service.

In this case, the PER may be derived for a given quality of service class identifier (QCI) for the desired service. For example, the PER may be derived from a lookup table.

In one possibility, the communication entity may further comprise means for receiving the results of measurements, from each said terminal device, wherein said results represent at least one of measured interference and measured noise in a communication channel on a communication link between the terminal device from which the measurement results are received and at least one other of said terminal devices, and wherein said determining means is operable to determine said characteristic value based on said measurement results.

In one possibility, the communication entity may further comprise means for receiving localisation information from at least one further communication entity (e.g. a Mobility Management Entity (MME)), wherein said determining means is operable to determine said characteristic value based on said localisation information.

In one possibility, the communication entity may further comprise means for receiving information identifying terminal device specific parameters (e.g. an antenna gain) from at least one further communication entity (e.g. a Mobility Management Entity (MME)), wherein said determining means is operable to determine said characteristic value based on said terminal device specific parameters.

In one possibility, the LAN may be a wireless LAN (WLAN). In this case, the WLAN may be a WLAN operating in accordance with IEEE 802.11 standards (or a derivative thereof). Alternatively, the WLAN may be a WLAN operating in accordance with IEEE 802.15 (also known as ‘Bluetooth’) standards (or a derivative thereof).

The communication entity may be a WLAN manager.

The radio access technology may be a radio access technology in accordance with 3rd Generation Partnership Project (3GPP) technical standards (or a derivative thereof). In this case, the radio access technology may be a radio access technology in accordance with long term evolution (LTE) 3GPP technical standards (or a derivative thereof—such as an LTE-Advanced 3GPP technical standard).

In one possibility, the minimum transmit power may be determined using the following equation:

$${P}_{Tx , min} ( i , j , chn ) = \frac{{P}_{Rx , min} ( i , j , chn )}{{G}_{i , j} \times {H}_{i , j} \times {d}_{i , j}^{- α}} \qquad [ Math . 9 ]$$

where P_{Rx,min}(i,j,chn) is a minimum received power from terminal device i to terminal device j in channel chn for all communication links; G_{i,j} is a gain value based on the antenna gain of both terminal device i and terminal device j; H_{i,j} is a mean channel gain value associated with a channel between terminal device i and terminal device j; d_{i,j}, is the distance between terminal device i and terminal device j; and α is an exponent to take account of path loss for the link between terminal device i and terminal device j.

According to another aspect of the present invention, there is provided a terminal device for a communication system in which terminal devices communicate with one another via a base station using a radio access technology, the terminal device comprising: means for receiving, from a communication entity of the communication system, information identifying that said terminal device has been selected to operate as an access node of a local area network (LAN) of said terminal devices; and means for communicating with the communication entity, and other terminal devices, to form a LAN of terminal devices in which said terminal device is the access node.

In one possibility, the communication means may be operable to communicate, in said LAN, using a communication channel in at least one communication link using at least a minimum transmit power that has been determined, by the communication entity, to provide a signal to noise ratio that meets a target signal to noise ratio.

In one possibility, the terminal device may further comprise means for providing the results of measurements, to the communication entity, wherein said results may represent at least one of measured interference and measured noise in a communication channel on a communication link between the terminal device from which the measurement results are received and at least one other of said terminal devices, and wherein said information identifying that the terminal device has been selected to operate as an access node may be provided by said communication entity based on said results of measurements.

The terminal device may comprise at least one of a mobile telephone and a portable computer device.

The present invention also provides a method performed by a communication entity for a communication system in which terminal devices communicate with one another via a base station using a radio access technology, the method comprising: identifying a plurality of said terminal devices for forming a potential local area network (LAN) of said terminal devices having at least one of said terminal devices operating as an access point via which each of the other terminal devices can communicate respectively using at least one communication channel in at least one of a plurality of communication links; determining, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN; wherein said determining step also comprises determining, for each terminal device, and each communication channel, a minimum transmit power required to ensure that said characteristic value meets an associated requirement for each communication link between that terminal device and each other terminal device; selecting a terminal device to operate as an access node of said local area network based on said determined minimum transmit powers for said terminal devices and said channels; and communicating with at least one of said plurality of terminal devices to identify which of said plurality of terminal devices has been selected to operate as an access node and/or which of said plurality of terminal devices has not been selected to operate as an access node.

The determining step may identify, for all communication links, for each terminal device and each communication channel, a power value representing a highest of said determined minimum transmit powers for that terminal device and communication channel; and said selecting step may select said terminal device to operate as said access node of said local area network based on said determined power values for said terminal devices and said channels.

The determining step may identify, for each terminal device, the channel exhibiting the lowest of said identified power values; and said selecting step may select, as said terminal device to operate as said access node of said local area network, the terminal device for which the identified channel exhibiting the lowest of said identified power values exhibits said lowest of said identified power values.

The present invention also provides a method performed by a terminal device for a communication system in which terminal devices communicate with one another via a base station using a radio access technology, the method comprising: receiving, from a communication entity of the communication system, information identifying that said terminal device has been selected to operate as an access node of a local area network (LAN) of said terminal devices; and communicating with the communication entity, and other terminal devices, to form a LAN of terminal devices in which said terminal device is the access node.

The communication step may comprise communicating, in said LAN, using a communication channel in at least one communication link using at least a minimum transmit power that has been determined, by the communication entity, to provide a signal to noise ratio that meets a target signal to noise ratio.

The invention also provides a communication system comprising at least one communication entity and at least one terminal device.

Aspects of the invention extend to computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

### Advantageous Effects of Invention

According to the present invention, it is possible to provide methods and apparatus which overcome or at least alleviate delays in the set-up of a local area network.

### BRIEF DESCRIPTION OF DRAWINGS

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Embodiments of the invention will now be described, by way of example, with reference to the accompanying drawings in which:

FIG. 1 illustrates schematically a cellular telecommunications system to which embodiments of the invention may be applied;

FIG. 2 is a simplified block diagram of a WLAN manager forming part of the system shown in FIG. 1:

FIG. 3 is a simplified block diagram of a mobility management entity (MME) forming part of the system shown in FIG. 1;

FIG. 4 is a simplified block diagram of a base station forming part of the system shown in FIG. 1;

FIG. 5 is a simplified block diagram of a terminal device forming part of the system shown in FIG. 1;

FIG. 6 is a simplified flow diagram that illustrates possible operation of a WLAN manager of the system shown in FIG. 1:

FIG. 7 is a simplified flow diagram that illustrates alternative operation of a WLAN manager of the system shown in FIG. 1;

FIG. 8 is a simplified flow diagram that illustrates another alternative operation of a WLAN manager of the system shown in FIG. 1; and

FIG. 9 is a simplified timing diagram that illustrates operation of the components of the system shown in FIG. 1 to configure a WLAN.

### DESCRIPTION OF EMBODIMENTS

### (Overview)

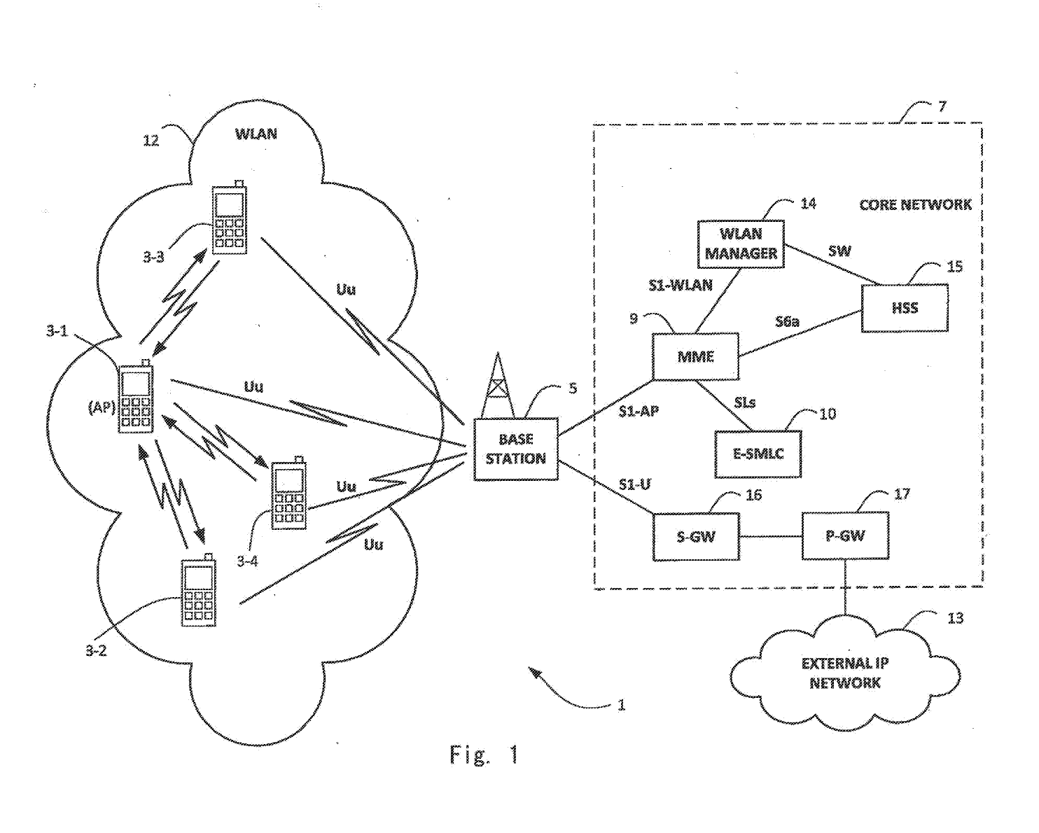

FIG. 1 schematically illustrates a long term evolution (LTE) telecommunications network 1 in which users of mobile terminal devices 3, such as mobile telephones, can communicate with each other and other users via a E-UTRAN base station 5 and a core network 7. As those skilled in the art will appreciate, although a particular number of terminal devices 3 and one base station 5 are shown for illustration purposes in FIG. 1, any number of terminal devices 3 and base stations may form part of the telecommunications network 1.

As is well known, a mobile terminal device 3 may enter and leave the areas (i.e. radio cells) served by the base station 5 as the terminal device 3 is moving around in the geographical area covered by the telecommunications system 1. In order to keep track of the terminal devices 3 and to facilitate movement between the different base stations 5, the core network 7 comprises a mobility management entity (MME) 9 which is in communication with the base station 5 coupled to the core network 7, and an enhanced serving mobile location centre (E-SMLC—also known as an ‘evolved’ SMLC) 10, which is coupled to the MME 9 via a communication interface referred to as an “SLs” interface (e.g. as described in 3GPP TS 29.171). The MME 9 can retrieve location related information from the E-SMLC 10 by sending an appropriately configured location request and receiving a location response including the location related information.

In this embodiment the terminal devices 3 can be interconnected as part of a WLAN network 12, via one of the terminal devices 3-1 operating as an access point (AP), with the other terminals 3-2 to 3-4, operating as stations (STA) of the WLAN. Whilst forming part of the WLAN network 12, the terminal devices 3 can also continue to access to the core network 7 through the base station 5. The MME 9 also continues to keep track of those terminal devices 3. A WLAN manager 14, which is located in the core network 7, controls the initial set-up of the WLAN dynamically, and the interconnection of the terminal devices 3, as part of the WLAN 12. This is achieved by the WLAN manager 14 communicating with a WLAN client of each terminal device 3.

The base station 5 is connected to the MME 9 via a so called “S1-AP” interface, also known as an “S1-MME” interface, which is defined in the 3GPP Technical Standard (TS) 36.413. The MME 9 is also connected to the WLAN manager 14 and a home subscriber server (HSS) 15 via a so-called “S1-WLAN” and “S6a” interfaces, respectively. The WLAN manager 14 and the HSS 15 are also connected via an interface, herein denoted by “SW”. For each terminal device 3, the HSS 15 stores subscription data (such as settings and preferences) and authorisations for accessing the core network 7 and the WLAN 12. The MME 9 and the WLAN manager 14 use the data stored in the HSS 15 for managing the connection of the terminal device 3 to the core network 7.

Each terminal device 3 communicates via an air interface (the so-called “Uu” interface) with the base station 5. The base station 5 and the serving gateway (S-GW) 16 communicate with one another via an “S1-U” interface. Communication between the core network and an external IP network 13, such as the Internet, is provided via a packet data network gateway (P-GW) 17 linked to the S-GW 16. It will be appreciated that, whilst shown as separate entities, the functionalities of the S-GW 16 and the P-GW 17 could be implemented in a single gateway element.

When connected to the WLAN 12, the terminal device 3-1 that operates as an access point, communicates with the other terminal devices 3-2, 3-3, 3-4 (stations/STA) via a WLAN air interface.

Advantageously, before the WLAN is formed, the WLAN manager 14 engages in a selection process to select both the terminal device 3 to use as an access point (AP), and the communication channel that should be used for communication in the WLAN, to ensure that the choice of AP and channel are optimised effectively. Beneficially, therefore, at initial configuration of the WLAN, the access point can be dynamically selected together with the communication channel. This solution therefore extends the range of covered use cases. Also, the WLAN will not affect other neighbour networks in the initial WLAN configuration phase since will not perform measurements nor other transmissions that might affect neighbour quality of service (e.g. if measurements/transmissions occur on the same channel).

In one example, the selection process in the WLAN manager 14 is based on the calculation of a characteristic value, referred to as a ‘simplified capacity’ (or a ‘simplified link capacity’), for each potential access point (e.g. each terminal device/station) and for each communications channel of that potential access point. The simplified capacity is not based on the results of actual quality related measurements, on a corresponding communications channel, acquired by an access point (e.g. of received power, interference, bit error rate, lost packets, or the like). Instead, the calculation of simplified capacity is beneficially based on a number of properties associated with, and measurements performed by, the terminal devices 3. The properties and measurements are available to the WLAN manager 14 via direct and/or indirect communication with other core network entities such as, for example, the MME 9 and the terminal devices 3 using the resources of the telecommunication network 1.

The simplified capacity is formulated to be generally indicative of the quality of service, on a particular channel of a communication link (uplink or downlink) between the potential access point and another terminal device 3 of the WLAN. Whilst the simplified capacity may not be as precise as an analysis of quality of service based on measurements by the access point (e.g. of received power, interference, bit error rate, lost packets, or the like), the simplified capacity provides a predictive estimate of the quality of service. The simplified capacity is compared to a target capacity (which may be referred to as a ‘target simplified capacity’) that represents a measure of the required quality of service for reception from the other terminal device 3. The difference between simplified capacity and target capacity (referred to as a ‘residual capacity’) arising from the comparison for all the channels can therefore be used to find the channel providing the best apparent quality of service for a potential access point.

In another example, the selection process in the WLAN manager 14 is based on the calculation of a required Signal-to-Noise Ratio (SNR) per link between each potential access point (e.g. each terminal device/station) and other terminal devices for each communications channel of that potential access point. The required SNR per link is not based on the results of actual quality related measurements, on a corresponding communications channel, acquired by an access point (e.g. of received power, interference, bit error rate, lost packets, or the like). Instead, the calculation of the required SNR per link is beneficially based on a number of properties associated with, and measurements performed by, the terminal devices 3. The properties and measurements are available to the WLAN manager 14 via direct and/or indirect communication with other core network entities such as, for example, the MME 9 and the terminal devices 3 using the resources of the telecommunication network 1.

Thus, beneficially, the use of the simplified capacity and/or the required SNR per link measure represents a low cost means by which the quality of service can be roughly evaluated and maximised, before the WLAN is formed, based on information reported to the WLAN manager through the core network 7. Quality of service can, effectively, be predicted before transmission commences instead of being measured by the access point after transmission commences. Once the WLAN configuration is initiated, the WLAN can therefore be set up i) without a significant delay (associated with the need to make quality related measurements and perform associated analysis at the access point) and ii) without interfering at all with other neighbour networks and thus increasing their transmission power during the measurement phase, making the measurement unreliable.

Further, because the access point is selected based on the simplified capacity and/or the required SNR per link associated with the communication channels to that access point (rather than being pre-determined) there are a larger number of access point/channel options to choose from and, consequently, the selected access point/channel configuration will, generally, provide a better quality of service (for a particular transmitter power) than would otherwise be the case.

Where there is no AP controlled by the operator in the radio range (e.g. vicinity), then the possibility of using one of the terminals as an AP provides additional benefits. Compared to the current approach, where the AP is fixed (i.e. defined by construction), therefore, this approach allows the network to choose both optimal channel and AP, whilst at the same time, increasing WLAN capacity.

It can be seen, therefore, that the use of the simplified capacity and/or the required SNR per link to select both an access point and a communication channel has potential benefits in a number of use cases for example: when a cellular network initiates establishment of a WLAN between the terminal devices 3 to enable direct device-to-device communication; and when a WLAN mesh needs to be formed dynamically for a specific reason such as to resolve communication congestion at an existing hotspot.

### (WLAN Manager)

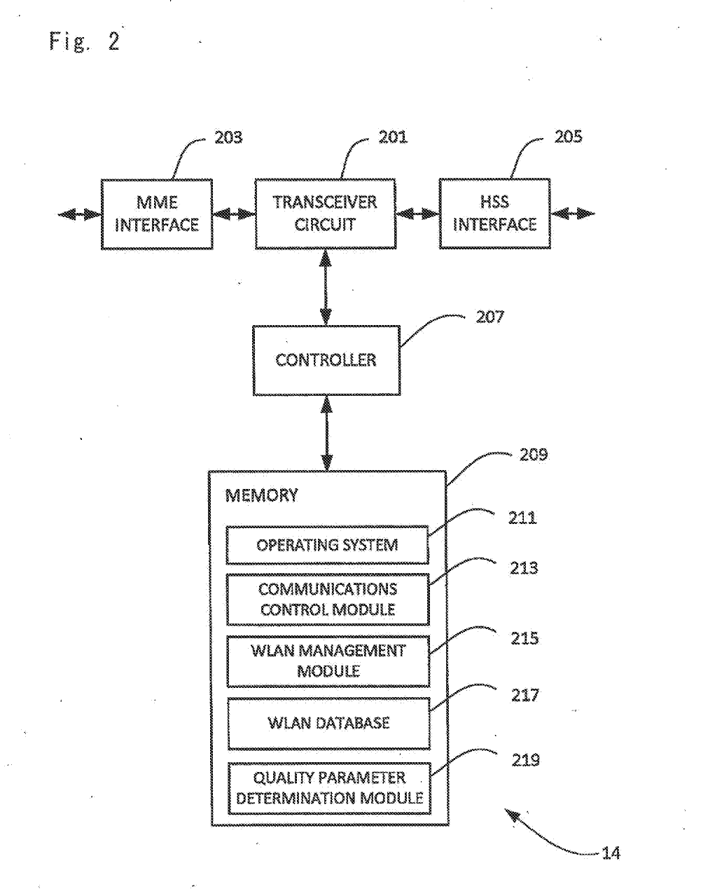

FIG. 2 is a block diagram illustrating the main components of the WLAN manager 14 shown in FIG. 1. As shown, the WLAN manager 14 includes transceiver circuitry 201 which is operable to transmit signals to, and to receive signals from: the MME 9 via an MME interface 203; and the HSS 15 via a home subscriber server (HSS) interface 205. The operation of the transceiver circuitry 201 is controlled by a controller 207 in accordance with software stored in memory 209. The software includes, among other things an operating system 211, a communications control module 213, a WLAN management module 215, a WLAN database 217, and a quality parameter determination module 219.

The communications control module 213 is operable to control the communication between the WLAN manager 14 and the MME 9 and other network entities that are connected to the WLAN manager 14.

The WLAN management module 215 performs the selection process to select both the terminal device 3 to use as an access point and the communication channel that should be used for communication in the WLAN 12 based on information provided by the quality parameter determination module 219. The WLAN management module 215 is also operable to generate WLAN control information for controlling the initial configuration (and subsequent reconfiguration if appropriate) of the WLAN 12. The WLAN control information may, for example, be generated upon request by the MME 9 or the HSS 15.

The WLAN database 217 holds a list of WLAN networks 12 that are known to the core network 7. The terminal devices 3 (and optionally, their IP addresses) might be associated with a number of WLAN networks 12 in the WLAN database 217.

The quality parameter determination module 219 performs the calculations of the simplified capacity (and residual capacity based on the calculated simplified capacities and target capacities) and/or the required SNR per link for use by the WLAN management module 215 in selecting the terminal device 3 to use as an access point and the communication channel that should be used for communication in the WLAN 12. The calculation of the simplified capacity and/or the required SNR per link is based on measurements acquired from the terminal devices 3 (e.g. of channel interference and noise) and information about the terminal devices 3 acquired from other core network entities (e.g. localisation information acquired from the MME 9 and/or the type of environment, such as indoor/outdoor). The measurements may be explicitly requested by the WLAN manager, or may be routinely sent to the network (e.g. in a periodic measurement report).

### (Mobility Management Entity)

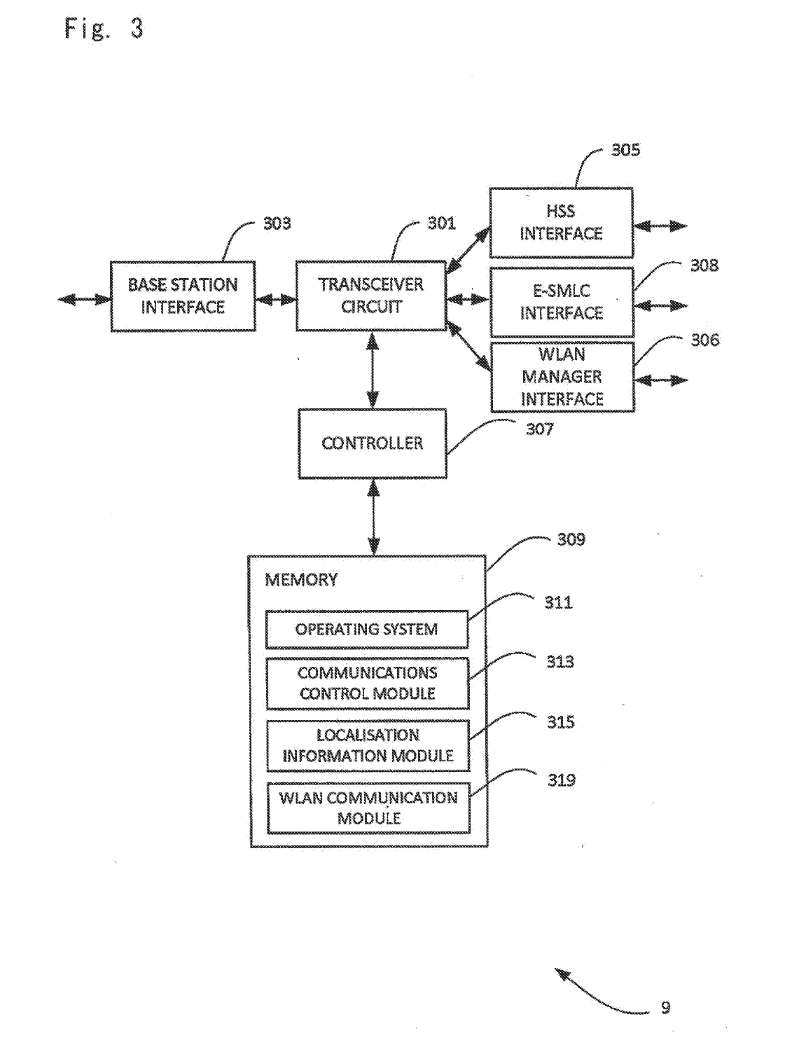

FIG. 3 is a functional block diagram illustrating the main components of the mobility management entity 9 shown in FIG. 1. As shown, the MME 9 includes transceiver circuitry 301 which is operable to transmit signals to, and to receive signals from: the base station 5 via a base station interface 303; the home subscriber server 15 via a home subscriber server (HSS) interface 305; the WLAN manager 14 via a WLAN manager interface 306; and the E-SMLC 10 via a E-SMLC interface 308. The operation of the transceiver circuitry 301 is controlled by a controller 307 in accordance with software stored in memory 309. The software includes, among other things an operating system 311, a communications control module 313, a localisation information module 315, and a WLAN communication module 319.

The communications control module 313 is operable to control the communication between the MME 9 and the network entities that are connected to the MME 9.

The localisation information module 315, maintains localisation information relating to the geographic location of the terminal devices 3 in range of the base station 5 (or within the range of each base station where the MME operates with a set of base stations) and provides the information to other network entities, such as the WLAN manager 14, when requested to do so. The localisation may be used, for example, by the WLAN manager 14 to determine a distance between different terminal devices 3 for the purposes of estimating the quality of service (e.g. calculating the simplified capacity and/or calculating the required SNR per communication link provided between those terminal devices on a particular communication channel. The localisation information module 315 may work in conjunction with the E-SMLC 10 to provide localisation information.

The WLAN communication module 319 is operable to control the transfer of the WLAN control information between the WLAN manager and a terminal device 3. For example, the WLAN communication module 319 can communicate the WLAN control information to the terminal device 3 via a mobility management entity 9 and/or a base station 5 serving this terminal device 3.

### (Base Station)

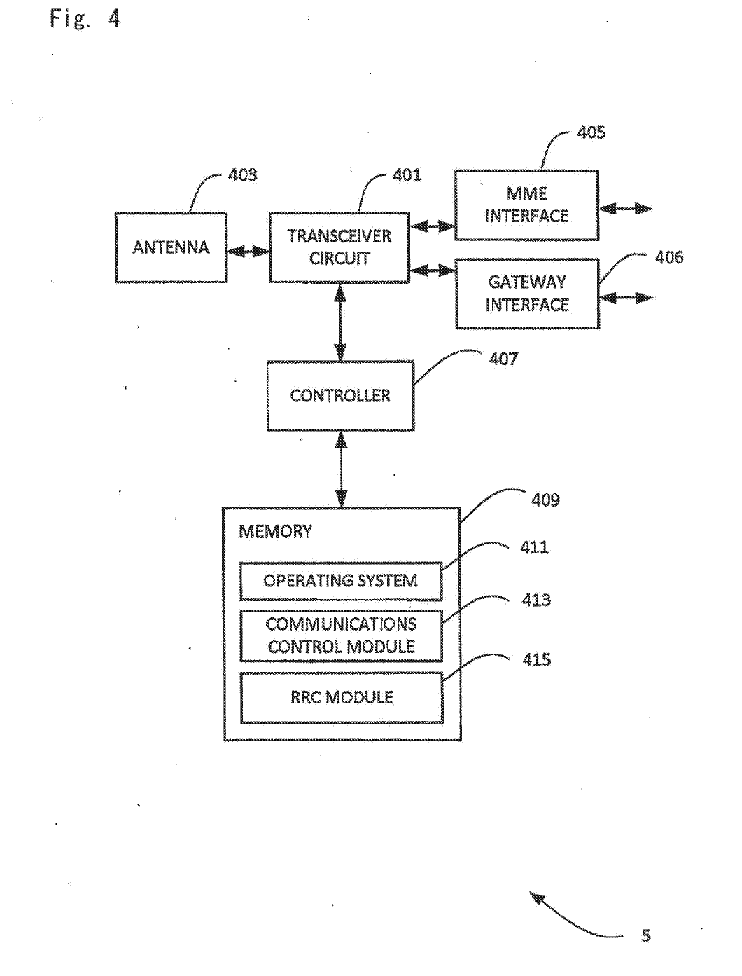

FIG. 4 is a block diagram illustrating the main components of the base station 5 shown in FIG. 1. As shown, the base station 5 has a transceiver circuit 401 for transmitting signals to and for receiving signals from the terminal devices 3 via one or more antenna 403, a mobility management entity (MME) interface 405 for transmitting signals to and for receiving signals from the mobility management entity 9, and a gateway interface 406 for transmitting signals to and for receiving signals from the gateways 16 and 17. The base station 5 has a controller 407 to control the operation of the base station 5. The controller 407 is associated with a memory 409. Although not necessarily shown in FIG. 4, the base station 5 will of course have all the usual functionality of a cellular telephone network base station and this may be provided by any one or any combination of hardware, software and firmware, as appropriate. Software may be pre-installed in the memory 409 and/or may be downloaded via the communications network 1 or from a removable data storage device (RMD), for example. The controller 407 is configured to control the overall operation of the base station 5 by, in this example, program instructions or software instructions stored within memory 409. As shown, these software instructions include, among other things, an operating system 411, a communications control module 413, and a Radio Resource Control (RRC) module 415.

The communications control module 413 is operable to control the communication between the base station 5 and the terminal devices 3 and other network entities that are connected to the base station 5. The communications control module 413 also controls the separate flows of downlink user traffic and control data to be transmitted to the terminal devices 3 associated with this base station 5 including, for example, control data for managing configuration and maintenance of the WLAN from the WLAN manager 14 via the MME 9.

The RRC module 415 is operable to generate, send and receive signalling messages formatted according to the RRC standard. For example, such messages are exchanged between the base station 5 and the terminal devices 3 that are associated with this base station 5. The RRC messages may include, for example, the control data for managing configuration and maintenance of the WLAN, provided by the MME 9 from the WLAN manager 14.

### (Terminal Device)

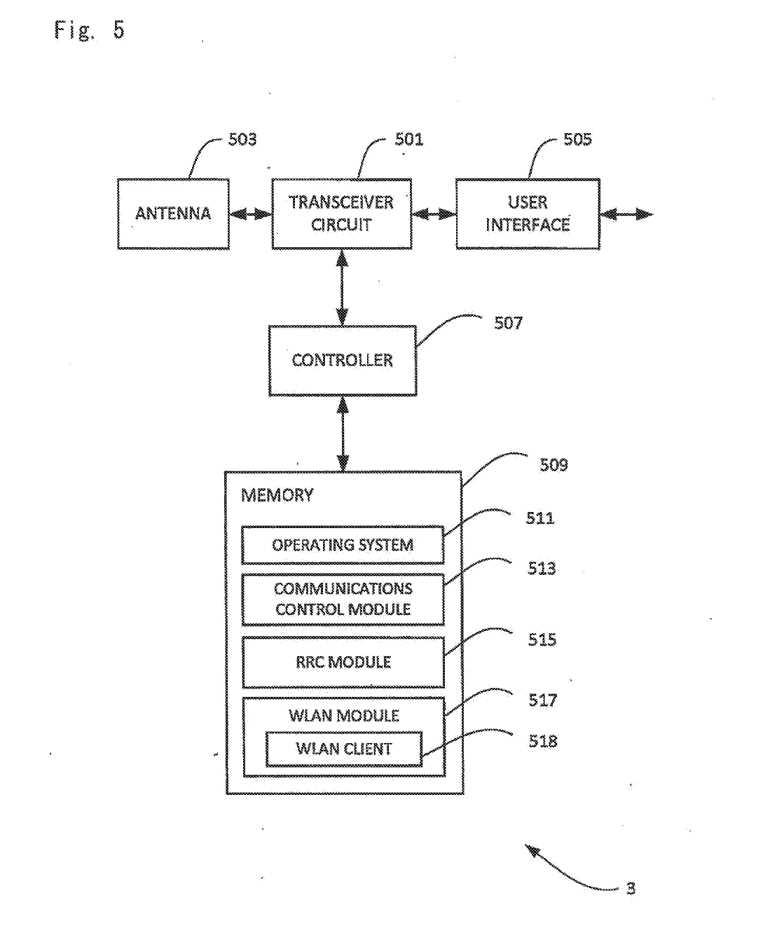

FIG. 5 is a block diagram illustrating the main components of the terminal device 3 shown in FIG. 1. As shown, the terminal device 3 has a transceiver circuit 501 that is operable to transmit signals to and to receive signals from a base station 5 via one or more antenna 503. The terminal device 3 has a controller 507 to control the operation of the terminal device 3. The controller 507 is associated with a memory 509 and is coupled to the transceiver circuit 501. Although not necessarily shown in FIG. 5, the terminal device 3 will of course have all the usual functionality of a conventional terminal device 3 (such as a user interface 505) and this may be provided by any one or any combination of hardware, software and firmware, as appropriate. Software may be pre-installed in the memory 509 and/or may be downloaded via the telecommunications network or from a removable data storage device (RMD), for example.

The controller 507 is configured to control overall operation of the terminal device 3 by, in this example, program instructions or software instructions stored within memory 509. As shown, these software instructions include, among other things, an operating system 511, and a communications control module 513, an RRC module 515, and a WLAN module 517.

The communications control module 513 is operable to control the communication between the terminal device 3 and other terminal devices 3 or the base station 5 or the access point 3-1. The communications control module 513 also controls the separate flows of uplink data and control data that are to be transmitted to the other terminal device 3, to the access point 3-1, or to the base station 5.

The RRC module 515 is operable to send and receive messages according to the RRC protocol, via the transceiver circuit 501 including, for example, the RRC messages comprising control data for managing configuration and maintenance of the WLAN, from the WLAN manager 14, and provided by the MME 9 via the base station 5.

The WLAN module 517 comprises a WLAN client 518 and is operable to control communication via the access point 3-1 based on the information stored in the memory 509 of the terminal device 3 and/or based on information received from the mobility management entity 9 via the base station 5 (e.g. in an RRC or other message). The WLAN module 517 manages the configuration and maintenance of the WLAN for a terminal device 3, based on the control information from the WLAN manager 14 received via the MME 9 and the base station 5, in appropriate RRC or other messages.

### (Selecting the Optimum Access Point and Optimum Channel—First Example)

The method for selecting the optimum access point and optimum channel will now be described in more detail.

The method uses the quality of service requirements for the various terminal device to terminal device communication links: to identify the worst communication links for all the potential access points; to identify the respective best channel for each of the worst communication links; and to select, as the access point, the terminal device that provides the best of all the identified best channels for the worst communication links.

More specifically, in this example, the method involves calculating a simplified capacity, as a worst case prediction of quality of service, of each possible communication link (including both uplinks and downlinks) in each available channel if terminal device i (for i=1, 2, . . . N) were to be the access point. In each access point-channel combination, the worst among all downlinks and uplinks is found. Then by comparing the worst links of all the access point-channel combinations, the best of the worst links is found. Hence, the corresponding access point and channel are chosen as the best choice of access point and channel.

The calculation of the simplified capacity for a particular communication channel of a communication link between the terminal device 3 at one end of the communication link (operating as a transmitter) and the terminal device 3 at the other end of the communication link (operating as a receiver) is based on the following equation:

$$C ( i , j , ch ) = {log}_{2} ( 1 + \frac{{P}_{i} \times {d}_{i , j}^{- α} \times {G}_{i , j} \times {H}_{i , j}}{{I}_{j , ch} + {n}_{j , ch}} ) , \\ for i , j = 1 , … , N and ch = 1 , … , M \qquad [ Math . 10 ]$$

where
C(i, j, ch) is the simplified capacity of the a communication link from terminal device i, to terminal device j, in channel ch;
Pᵢ is a transmit power attributed to the terminal device i by the WLAN manager;
d_{i,j} is the distance between terminal device i and terminal device j (determined from localisation information provided by the MME/E-SMLC);
α is an exponent to take account of path loss for the link between terminal device i and terminal device j, and is dependent on a number of different variables including, in particular, the type of environment in which the WLAN is located (e.g. height or e.g. in an Urban/Rural environment where e.g., αε[3,4]/αε[2,3], or indoor/outdoor, etc. i) provided by MME or its components or ii) provided by devices and stored in WLAN manager database);
G_{i,j} is a gain value based on the antenna gain of both terminal device i and terminal device j (determined from information provided by the terminal devices in question and possibly but not necessary stored in HSS);
H_{i,j} represents the mean gain of the communication channel between transmitter i and receiver j;
I_{j,ch} is a measure of the interference measured at the terminal device j in communication channel ch (determined from information provided by the terminal devices in question);
n_{j,ch} is a measure of the Gaussian noise measured at the terminal device j in communication channel ch (determined from information provided by the terminal devices in question);
M is the number of channels
N is the number of terminal devices in the potential WLAN for which the simplified capacity can be calculated

The simplified capacity does not take account of so called ‘fast fading’ and may therefore be considered to provide a static measure of the quality of the communication link. The greater the simplified capacity, the greater the mean link quality of service is.

The target simplified capacity for a communication link to a particular terminal device j operating as a receiver (representing a measure of the quality of service requirement when communicating to the terminal device j as explained above) is assumed, in this embodiment, to be the same for all channels on the communication link to that receiver and is defined as C₀(j). Thus, the residual capacity for a particular communication channel ch of a communication link from a terminal device i (operating as a transmitter) to a terminal device j (operating as a receiver) may be defined as:

Δ(_{i,j,ch})=C(i,j,ch)−C₀(j) [Math. 11]

The residual capacity therefore provides a measure of ‘link quality of service’ for a particular communication link. If the residual capacity is positive, then the required link quality of service is considered to be achievable, otherwise the link quality of service is considered not to be achievable.

According to these definitions, therefore, if a terminal device i were to be the access point, the vector of the link residual capacities for the communication links from terminal device i to the other terminal devices (downlinks) and for the communication links from the other terminal devices to terminal device i (uplinks) may be defined

$$( \begin{matrix}Δ ( i , : , ch ) \\ Δ ( : , i , ch )\end{matrix} ) .$$

The element Δ(i,:,ch) is for the downlink, the element Δ(:,i,ch) is for the uplink and each element is respectively defined as follows:

$$Δ ( i , : , ch ) = ( \begin{matrix}Δ ( i , 1 , ch ) \\ Δ ( i , 2 , ch ) \\ ⋮ \\ Δ ( i , N , ch )\end{matrix} ) ; \\ Δ ( : , i , ch ) = ( \begin{matrix}Δ ( 1 , i , ch ) \\ Δ ( 2 , i , ch ) \\ ⋮ \\ Δ ( N , i , ch )\end{matrix} ) \qquad [ Math . 12 ]$$

For the communication links from and to a particular terminal device i using a particular communication channel ch, the residual capacity of the communication link considered to be the ‘worst’ is denoted χ(i, ch). χ(i, ch) is defined, in this embodiment, as being the minimum residual capacity for all the communication links from and to terminal device i using communication channel ch, which may be represented mathematically as follows:

$$χ ( i , ch ) = Min ( \begin{matrix}Δ ( i , : , ch ) \\ Δ ( : , i , ch )\end{matrix} ) \qquad [ Math . 13 ]$$

Accordingly, it can be seen that for all communication channels used for communication by terminal device i, the communication channel having the highest among the communication links having the ‘worst’ residual capacities is the channel that maximises the vector χ(i, :):

└Ψ(i)CHₒₚₜ(i)┘=Maxχ(i,:) [Math. 14]

where Ψ(i) is the maximum of vector χ(i, :), and CHopt(i) is the index of the maximum in vector χ(i, :). Therefore, the index of the communication channel having the highest among the communication links having the ‘worst’ residual capacities is CHopt(i). In this embodiment, the communication channel having the highest among the ‘worst’ residual capacity is considered to be the ‘best’ or ‘optimum’ channel to select if the terminal device i were to be the access point.

It can be seen, therefore, that the vector Ψ is a vector with a plurality of elements Ψ(i) as follows:

$$Ψ = ( \begin{matrix}Ψ ( 1 ) \\ Ψ ( 2 ) \\ ⋮ \\ Ψ ( N )\end{matrix} ) \qquad [ Math . 15 ]$$

Each element Ψ(i) represents the maximum residual capacity achievable for a particular terminal device i, for all communication channels, on the communication link deemed to be ‘worst’ for that terminal device i (as defined above). Each element Ψ(i) is therefore considered to represent the best amongst the worst communication links, if terminal device i (for i=1 . . . N) were to be the access point.

The terminal device i providing the highest residual capacity for all communication channels, on the communication link deemed to be ‘worst’ for that terminal device i is, in this embodiment, considered to represent the ‘best’ or ‘optimum’ choice, for selection as the access point, among all the terminal devices. The ‘best’ or ‘optimum’ choice of terminal device, for selection as the access point corresponds to terminal device i that maximises the vector Ψ may therefore be represented as follows:

[BWRC AP_{index}]←Max Ψ [Math. 16]

where BWRC refers to a value of so called ‘Best Worst Residual Capacity’ and is the maximum of Ψ among all the communication links and channels and AP_{index} is the index of the terminal device deemed to be the ‘best’ or ‘optimum’ choice, for selection as the access point, among all the terminal devices. BWRC can thus be seen to represent the maximum residual capacity achievable for all terminal devices, over all communication channel for each terminal device, on the communication links deemed to be ‘worst’ for each of those terminal devices.

Thus, the terminal device represented by AP_{index} may be selected, in this embodiment, to be the ‘best’ or ‘optimum’ choice of access point for the WLAN.

The index of the channel, Channel_{index} providing the highest residual capacity may therefore be found as follows:

Channel_{index}←CHₒₚₜ(AP_{index}). [Math. 17]

Thus, the channel represented by Channel_{index} may be selected, in this embodiment, to be the ‘best’ or ‘optimum’ channel choice for communication in the WLAN.

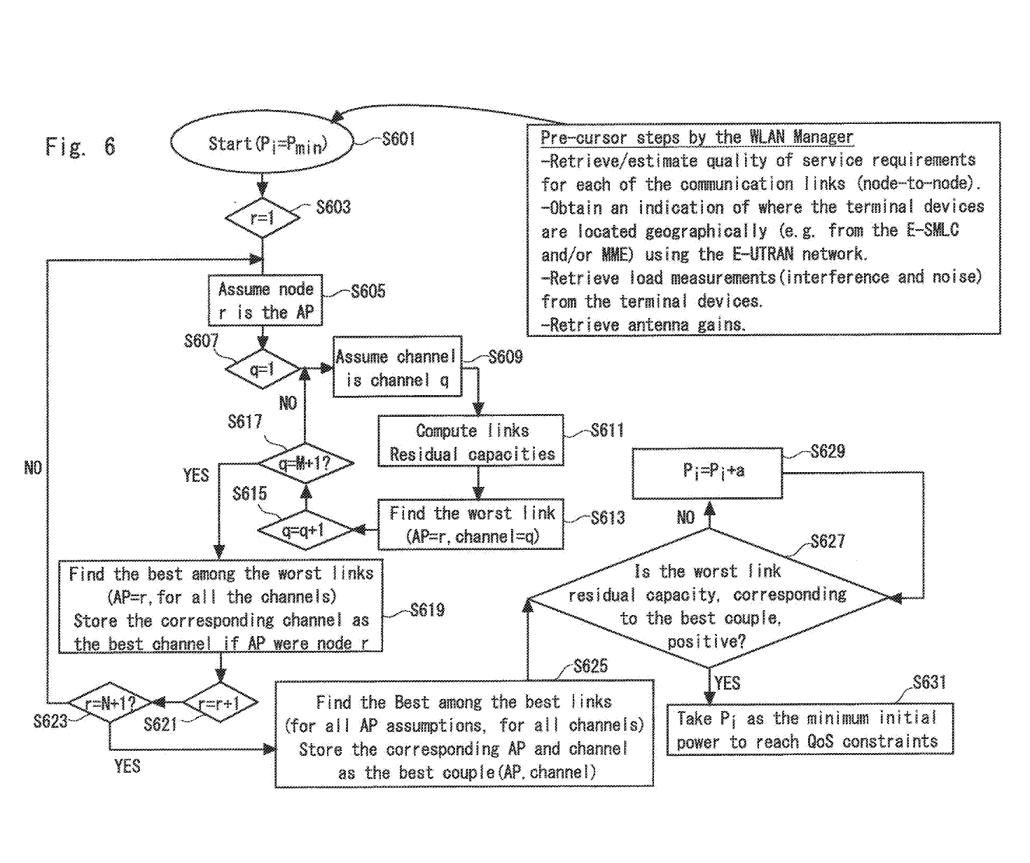

An example flowchart of this example of WLAN configuration algorithm will be described with reference to FIG. 6.

Advantageously, for power minimisation, the process of determining the best channel and access point can be initialised using the minimum allowed transmit power for all the candidate terminal devices. At the end of the method, if BWRC is negative (indicating that the quality of service requirement for BWRC has not been met) then the transmit power can be increased and BWRC recalculated in an iterative process until BWRC becomes positive. Using this approach, therefore, the final transmit power is beneficially the minimum required to configure the WLAN.

### (Selecting the Optimum Access Point and Optimum Channel—Second Example)

The method for selecting the optimum access point and optimum channel will now be described in more detail.

In this example, the method uses the Quality of Service Class Identifier (QCI) for the various terminal device to terminal device communication links: to check (and find) any potential AP/channel pairs that meet the given QCI requirements (i.e. per-link QCI requirement). QCI is specified in 3GPP TS 23.203 v 11.7.0, the contents of which are incorporated herein by reference.

More specifically, the method of this example involves using Packet Error Rate (PER) requirements from the QCI and modulation characteristics of the WLAN technology to derive a required Signal-to-Noise Ratio per link—here denoted by SNRreq. This derived QoS parameter is then used to determine if the communication link will be compliant with predetermined requirements (e.g. those set out in the associated standards). The modulation characteristics of the WLAN technology might include, for example, DBPSK (Differential Binary Phase Shift keying), DQPSK (Differential Quadrature Phase Shift Keying) and CCK (Complementary Code Keying) modulations in case of the IEEE 802.11b standard and other modulations in case of other standards.

The method also involves verifying, for each potential AP/channel combination, the PER achievability by checking whether the Initial Transmission Power multiplied by the mean channel condition of each terminal device and of each link, meets a required ‘per-link’ PER. In order to meet the per-link PER, prior to communication, the estimated mean SINRs (Signal-to-Interference-plus-Noise Ratio) of all the links must be higher than the aforementioned SNRreq.

In this way, by going through the set of possible AP/channel combinations, it is possible to check if there is any AP/channel pair that achieves the ‘per-link’ PER for each of the possible link. Once a compliant AP/channel pair is found, it is returned by the WLAN manager 14 for setting up a WLAN. If no compliant potential AP/channel pair is found, then the algorithm terminates and informs that no compliant AP/channel pair is available.

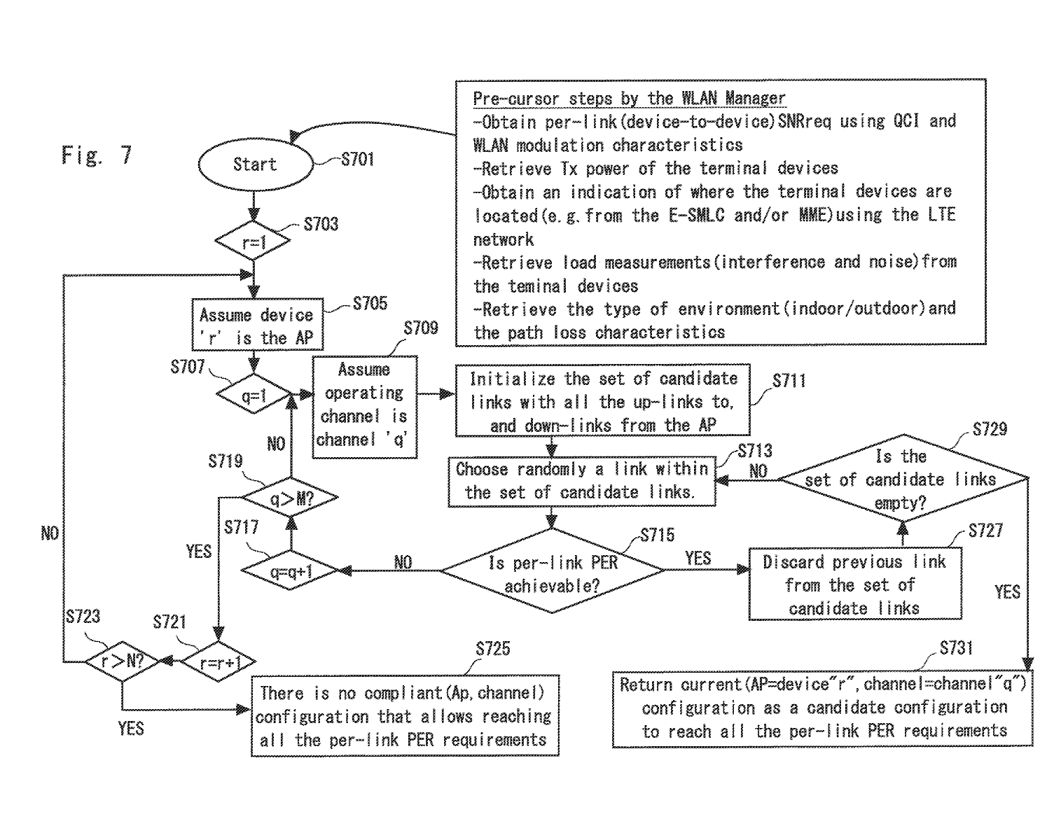

An example flowchart of the second example of WLAN configuration algorithm will be described with reference to FIG. 7.

The WLAN manager 14 derives the required SNR (i.e. SNRreq) as follows: For a given QCI, the WLAN manager 14 determines the corresponding PER. The PERs for various QCI, resource types (guaranteed bit rate (GBR) or ‘real time’/non-guaranteed bit rate (non-GBR) or ‘non-real time’), assigned service priority, service types and/or the like are defined in the associated standards. Examples of typical PERs are shown in Table 1 below.

TABLE 1

| | | | Packet | | | |
|---|---|---|---|---|---|---|
| | Resource | | Delay | | | |
| QCI | Type | Priority | Budget | | PER | Example Services |
| 1 | Guaranteed Bit | 2 | 100 | ms | 10⁻² | Conversational Voice |
| 2 | Rate | 4 | 150 | ms | 10⁻³ | Conversational Video |
| | | | | | | (Live Streaming) |
| 3 | | 3 | 50 | ms | 10⁻³ | Real Time Gaming |
| 4 | | 5 | 300 | ms | 10⁻⁶ | Non-Conversational |
| | | | | | | Video (Buffered |
| | | | | | | Streaming) |
| 5 | Non-Guaranteed | 1 | 100 | ms | 10⁻⁶ | IMS Signalling |
| 6 | Bit Rate | 6 | 300 | ms | 10⁻⁶ | Video (Buffered |
| | | | | | | Streaming) TCP- |
| | | | | | | based (e.g., www, |
| | | | | | | e-mail, chat, ftp, |
| | | | | | | p2p file sharing, |
| | | | | | | progressive video, etc.) |
| 7 | | 7 | 100 | ms | 10⁻³ | Voice, Video |
| | | | | | | (Live Streaming), |
| | | | | | | Interactive Gaming |
| 8 | | 8 | 300 | ms | 10⁻⁶ | Video (Buffered |
| 9 | | 9 | | | | Streaming) |
| | | | | | | TCP-based (e.g., www, |
| | | | | | | e-mail, chat, |
| | | | | | | ftp, p2p file sharing, |
| | | | | | | progressive video, etc.) |

Table 1-source: 3GPP TS 23.203 v11.7.0 (September 2012)

Using the error independence assumption, the WLAN manager 14 derives a Bit Error Rate (BER) from the PER:

$$BER = 1 - {( 1 - PER )}^{\frac{1}{{L}_{max}}} \qquad [ Math . 18 ]$$

where Lₘₐₓ is the maximum length of the packet (maximum number of bits contained in a packet).

Next, by taking into consideration the modulation type of the WLAN technology (e.g., IEEE 802.11b uses DBPSK (Differential Binary Phase Shift keying), DQPSK (Differential Quadrature Phase Shift Keying) and CCK (Complementary Code Keying) modulations), the WLAN manager 14 retrieves the BER-SNR characteristic of the WLAN technology under the so-called ‘Additive White Gaussian Noise (AWGN)’ assumption (with which those skilled in the art will be familiar). The BER-SNR characteristic of a given modulation in an AWGN environment is, essentially, the curve of BER versus E_{b}/N₀, where E_{b} is the energy per bit, and N₀ is the noise power spectral density (noise power within a 1 Hz bandwidth). The BER-SNR characteristic in an AWGN environment is generally known to those skilled in the art and thus, for the sake of clarity, will not be described in more detail. Using the BER-SNR characteristic and given the BER value, the WLAN manager 14 derives a value of E_{b}/N₀.

The required SNR, SNRreq, is then given by the following formula:

$${SNR}_{req} = \frac{{R}_{b}}{W} \times \frac{{E}_{b}}{{N}_{0}} \qquad [ Math . 19 ]$$

where R_{b} is the bit rate of the WLAN technology and W is the communication bandwidth of the WLAN technology (for example, in case of IEEE 802.11b using DBPSK modulation, R_{b}=1 Mbit/s while W=20 MHz). It will be appreciated that in some cases the particular technology does not use the entire band. For example, the 802.11a standard uses only 48 subcarriers (from a total of 64 subcarriers) for IFFT/FFT transform, because 4 of the subcarriers are used as pilots and 6+6 (at either side of the band) of them are unused.

For each particular link, the PER achievability is checked as follows.

The WLAN manager 14 computes the mean SINR of the link from terminal device i to terminal device j, operating in channel chn, as follows:

$$SINR ( i , j , chn ) = \frac{{P}_{Tx} ( i , j ) \times {G}_{i , j} \times {H}_{i , j} \times {d}_{i , j}^{- α}}{{N}_{0} \times W + I ( j , chn )} \qquad [ Math . 20 ]$$

where P_{Tx}(i, j) is the Initial Transmission Power of terminal device i to terminal device j, and I(j,chn) is the interference level in channel chn measured at receiver j. The term N₀×W+I(j,chn) represents the harmful signal power in channel chn at receiver j; that is measured by terminal device j (before WLAN establishment) and sent to the WLAN manager 14. The term G_{i,j} represents the antenna gain accounting for the antenna gain of both the transmitter i and the receiver j. H_{i,j} represents the mean gain of the communication channel between transmitter i and receiver j. The distance between terminal device i and terminal device j is represented by d_{i,j}, and the path-loss exponent of the communication environment is noted α. It will be appreciated that other propagation models can also be used for computing the SINR, for example, the Okumura-Hata propagation model.

If SINR (i,j,chn)≧SNR_{req} then the WLAN manager 14 concludes that the PER requirement for the given terminal device i to terminal device j link using channel chn can be achieved. Otherwise, the WLAN manager 14 concludes that the PER requirement cannot be achieved.

As mentioned before, each terminal device can be chosen as the AP. The goal of the method is, on one hand to choose a terminal device as AP, and on the other hand to select an operating channel. The joint AP selection and channel allocation must meet the per-link PER requirements.

Therefore, a particular AP/channel pair is compliant if and only if the per-link PER requirement is achieved for all the links (uplinks and downlinks). It will be appreciated that it is possible that the WLAN manager 14 is not able to find any potential AP/channel combination for which the above criterion is met. In this case, the WLAN cannot be configured to meet the QCI requirements using this exemplary method.

### (Selecting the Optimum Access Point and Optimum Channel—Third Example)

In this example, the method uses the Quality of Service Class Identifier (QCI) for the various terminal device to terminal device communication links: to check (and find) any potential AP/channel pairs that meet the given QCI requirements (i.e. per-link QCI requirement).

More specifically, the method of this example also involves using Packet Error Rate (PER) requirements from the QCI and modulation characteristics of the WLAN technology to derive a required Signal-to-Noise Ratio per link—here denoted by SNRreq. This derived QoS parameter is then used to determine if the communication link will be compliant with predetermined requirements (e.g. those set out in the associated standards).

However, this exemplary method also involves deriving, by the WLAN manager 14, the minimum required mean transmission powers for each possible transmitter and receiver in the WLAN to be formed. In order to meet the per-link PER, prior to communication, the estimated mean SINRs (Signal-to-Interference-plus-Noise Ratio) of all the links must be higher than the aforementioned SNRreq.

In this way, by going through the set of possible AP/channel combinations, it is possible to find, for each AP/channel pair, the maximum of the aforementioned minimum required mean transmission powers. The most efficient AP/channel pair is the configuration with the lowest “maximum of the required mean transmission powers”.

This exemplary method thus beneficially identifies the most power efficient AP/channel combination and the required mean transmission powers for all the links in the WLAN to be formed.

The WLAN manager 14 derives the required SNR (i.e. SNRreq) as follows: For a given QCI, the WLAN manager 14 determines the corresponding PER (e.g. as described above). Then, using the error independence assumption, the WLAN manager 14 derives a Bit Error Rate (BER) from the PER:

$$BER = 1 - {( 1 - PER )}^{\frac{1}{{L}_{max}}} \qquad [ Math . 21 ]$$

where Lₘₐₓ is the maximum length of the packet (maximum number of bits contained in a packet).

Next, by taking into consideration the modulation type of the WLAN technology (e.g., IEEE 802.11b uses DBPSK (Differential Binary Phase Shift keying), DQPSK (Differential Quadrature Phase Shift Keying) and CCK (Complementary Code Keying) modulations), the WLAN manager 14 retrieves the BER-SNR characteristic of the WLAN technology under the so-called ‘Additive White Gaussian Noise (AWGN)’ assumption (with which those skilled in the art will be familiar). The BER-SNR characteristic of a given modulation in an AWGN environment is, essentially, the curve of BER versus E_{b}/N₀, where E_{b} is the energy per bit, and N₀ is the noise power spectral density (noise power within a 1 Hz bandwidth). The BER-SNR characteristic in an AWGN environment is generally known to those skilled in the art and thus, for the sake of clarity, will not be described in more detail. Using the BER-SNR characteristic and given the BER value, the WLAN manager 14 derives a value of E_{b}/N₀.

The required SNR, SNRreq, is then given by the following formula:

$${SNR}_{req} = \frac{{R}_{b}}{W} \times \frac{{E}_{b}}{{N}_{0}} \qquad [ Math . 22 ]$$

where R_{b} is the bit rate of the WLAN technology and W is the communication bandwidth of the WLAN technology (for example, in case of IEEE 802.11b using DBPSK modulation, R_{b}=1 Mbit/s while W=20 MHz). It will be appreciated that in some cases the particular technology does not use the entire band. For example, the 802.11a standard uses only 48 subcarriers (from a total of 64 subcarriers) for IFFT/FFT transform, because 4 of the subcarriers are used as pilots and 6+6 (at either side of the band) of them are unused.

Next, the minimum required transmission power is computed for each particular link to/from each potential access point and channel combination. The WLAN manager 14 ensures that the mean SINR of a particular link from terminal device i to terminal device j, operating in channel chn, is higher than the corresponding SNRreq as follows:

$$SINR ( i , j , chn ) = \frac{{P}_{Rx} ( i , j , chn )}{{N}_{0} \times W + I ( j , chn )} \\ SINR ( i , j , chn ) \geq {SNR}_{req} \\ ⇒ {P}_{Rx , min} ( i , j , chn ) = {SNR}_{req} \times [ {N}_{0} \times W + I ( i , j , chn ) ] \qquad [ Math . 23 ]$$

where P_{Rx}(i,j,chn) is the mean received power from terminal device i to terminal device j in channel chn and I(j,chn) is the interference level in channel chn at receiver j. The term N₀×W+I(j,chn) represents the harmful signal power in channel chn at received j, as measured by terminal device j and sent to the WLAN manager 14. The term P_{Rx,min}(i,j,chn) is the minimum required mean received power (from terminal device i to terminal device j in channel chn) in order to reach the PER requirement.

The minimum required mean transmission power P_{Tx,min}(i,j,chn) is given from the minimum required mean received power P_{Rx,min} in as follows:

$${P}_{Rx , min} ( i , j , chn ) = {P}_{Tx , min} ( i , j , chn ) \times {G}_{i , j} \times {H}_{i , j} \times {d}_{i , j}^{- α} \\ ⇒ {P}_{Tx , min} ( i , j , chn ) = \frac{{P}_{Rx , min} ( i , j , chn )}{{G}_{i , j} \times {H}_{i , j} \times {d}_{i , j}^{- α}} \qquad [ Math . 24 ]$$

where G_{i,j} represents the antenna gain accounting for the antenna gain of both the transmitter i and the receiver j; and H_{i,j} represents the mean gain of the communication channel between transmitter i and receiver j. The distance between terminal device i and terminal device j is represented by d_{i,j}, and the path-loss exponent of the communication environment is noted α. The value of H_{i,j} may be chosen to be ‘1’, e.g. for a simplistic channel prediction. Alternatively, the value of H_{i,j} may be computed using a channel modelling such as Rayleigh, Jakes, etc. For example, H_{i,j}×d_{i,j}^{-α} can be replaced with the Okumura-Hata propagation model, or computed from actual measurements (e.g. when looking for reconfiguration of an existing WLAN), or any other suitable method.

As mentioned before, each terminal device can be chosen as the AP. The goal of the method is, on one hand to choose a terminal device as AP, and on the other hand to select an operating channel that would result in the minimum required transmission powers in the WLAN to be formed.

The WLAN manager 14 determines the most power efficient AP/channel pair as follows.

For each terminal device assumed to be the access point (i.e. terminal device k), and for each channel assumed to be the operating channel (i.e. channel ch), the WLAN manager 14 determines the maximum of the set of links' minimum required mean transmission powers:

MaxP_{Tx,min}^{k,ch}=Max_{(i,j)ε{(k,j);j≠k}∪{(i,k);i≠k}}{P_{Tx,min}^{k,ch}(i,j,ch)} [Math. 25]

where MaxP_{Tx,min}^{k,ch} represents the maximum of the set of links' minimum required mean transmission powers for the terminal device k being assumed to be the access point and the channel ch being assumed to be the operating channel.

The WLAN manager 14 then obtains the most power efficient channel for the terminal device that is assumed to be the access point (i.e. terminal device k) by finding the channel that exhibits the minimum of all the MaxP_{Tx,min}^{k,ch} with ch=1, 2, . . . , M, as follows:

└MinMaxP_{Tx,min}^{k,Ch}^{ₒₚₜ}^{(k)},Chₒₚₜ(k)┘=Min_{ch=1,2, . . . ,M}{MaxP_{Tx,min}^{k,ch}} [Math. 26]

where MinMaxP_{Tx,min}^{k,Ch}^{ₒₚₜ}^{(k)} represents the minimum of the MaxP_{Tx,min}^{k,ch} with ch=1, 2, . . . , M. The term Chₒₚₜ(k) represents the index of the channel which exhibits MinMaxP_{Tx,min}^{k,Ch}^{ₒₚₜ}^{(k)}.

The WLAN manager 14 then obtains the best access point candidate by finding, among all the terminal devices assumed to be the access point, the terminal device which exhibits the minimum of MinMaxP_{Tx,min}^{k,Ch}^{ₒₚₜ}^{(k)} for k=1, 2, . . . , N as follows:

└MinMinMaxP_{Tx,min}^{k}^{ₒₚₜ}^{,Ch}^{ₒₚₜ}^{(k}^{ₒₚₜ}⁾,kₒₚₜ┘=Min_{k=1,2, . . . ,N}{MinMaxP_{Tx,min}^{k,Ch}^{ₒₚₜ}^{(k)}} [Math. 27]

where MinMinMaxP_{Tx,min}^{k}^{ₒₚₜ}^{,Ch}^{ₒₚₜ}^{(k}^{ₒₚₜ}⁾ represents the minimum of MinMaxP_{Tx,min}^{k,Ch}^{ₒₚₜ}^{(k)} for k=1, 2, . . . , N. The term kₒₚₜ is the index of the best UE/STA AP assumption.

Finally, the WLAN manager 14 determines that the (kₒₚₜ, Chₒₚₜ(kₒₚₜ)) pair is the most power efficient AP/channel configuration that allows reaching the required per-link PER, wherein kₒₚₜ is the access point index and Chₒₚₜ(kₒₚₜ) is the channel index for configuring the WLAN.

The joint AP selection and channel allocation method of this example thus beneficially results in the most efficient configuration of the WLAN to be formed with respect to transmission powers required whilst meeting the per-link PER requirements as well.

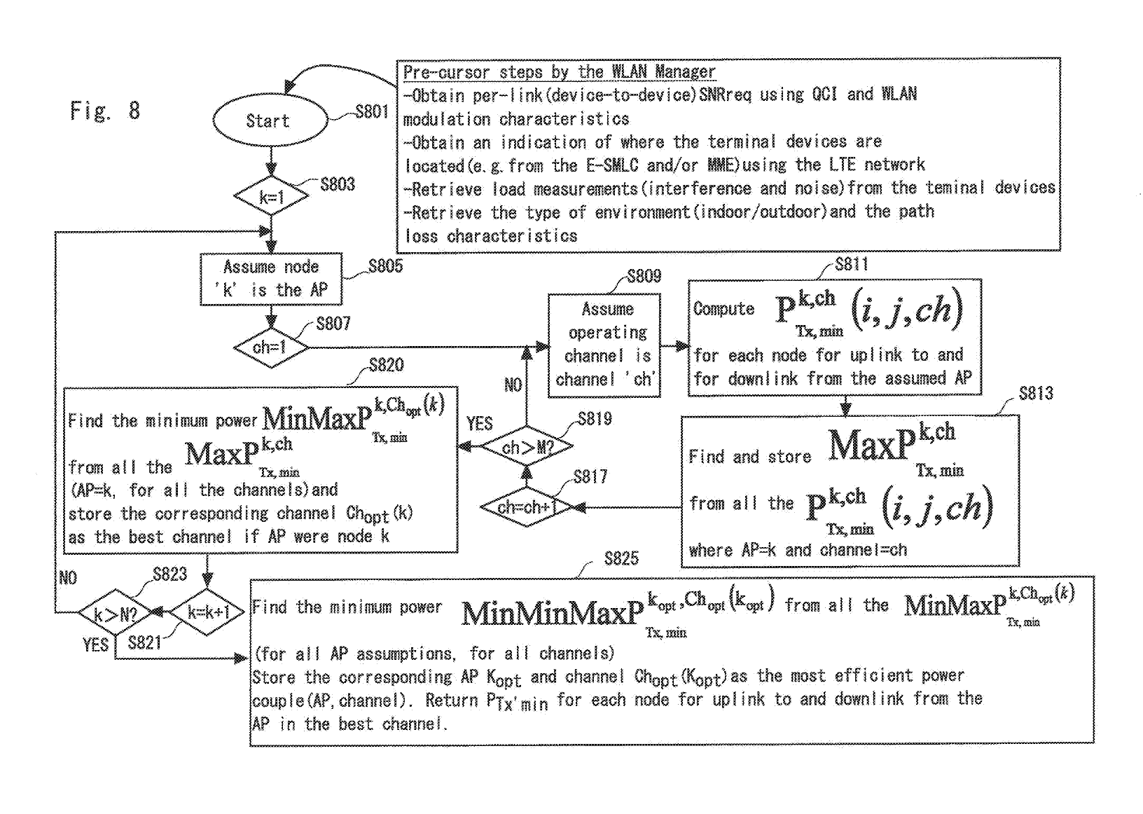

An example flowchart of the third example of WLAN configuration algorithm will be described with reference to FIG. 8.

### (Operation—First Example)

Operation of the WLAN manager 14, to select the optimum access point and optimum channel will now be further described with reference to FIG. 6 which shows a simplified flow chart showing the steps followed by the WLAN manager 14.

Before the selection process shown in FIG. 6 begins, the WLAN manager 14 obtains information identifying the quality of service requirements for the communication links (terminal device to terminal device) between the various terminal devices 3 that will ultimately make up the WLAN. In this embodiment, the WLAN manager 14 estimates the quality of service requirements. It will be appreciated that the WLAN manager 14 could potentially obtain the quality of service requirements from another network entity or retrieve pre-stored information identifying such requirements from its memory. The WLAN manager 14 also obtains an indication of where the terminal devices are located geographically from the E-SMLC 10 via the MME 9 using the E-UTRAN network. Further, the WLAN manager 14 retrieves measurements of interference and noise from the terminals (e.g. via the other entities in the E-UTRAN network), and information identifying the terminal device's antenna gains, upon which to base the simplified capacity calculation.

The selection process starts at S601 by initially setting the transmit power for each terminal device i (Pᵢ) to the minimum allowed transmit power (Pₘᵢₙ) for all the candidate terminal devices 3. The candidate terminal devices 3 each numbered with a unique index number which, in this embodiment, ranges from 1 through to ‘N’ (the total number of candidate terminal devices). After initialising a constant (in FIG. 6 shown as ‘r’) to 1 (at S603), the terminal device having index r is taken to be the access point at S605.

Each communication channel, which may be used by the terminal device that is being treated by the access point is numbered with a unique index number which, in this embodiment, ranges from 1 through to ‘M’ (the total number of communication channels for the device). After initialising a further constant (in FIG. 6 shown as ‘q’) to 1 (at S607), the communication channel having index q is taken to be the channel for which the simplified (and hence residual) capacity is to be calculated at S609.

The WLAN manager 14 then computes, as S611, the residual capacity of the communication channel q for each communication link (uplink and downlink) for the terminal device r that is taken to be the access point. The WLAN manager 14 determines, at S613, which of the communication links has the lowest (or most negative) residual capacity and this communication link is identified to be the ‘worst’ communication link at S613. The constant q is then incremented and, if the total number of channels, M, has not been reached (at S617) the loop from S609 to S615 is repeated and hence residual capacities are calculated and the ‘worst’ communication link identified for each communication channel of the terminal device taken to be the access point.

When the total number of channels, M, has been reached at S617, the WLAN manager 14 identifies, from all the identified ‘worst’ communication links, the communication link/communication channel combination that exhibits the highest residual capacity for the terminal device taken to be the access point. The communication channel exhibiting the highest overall ‘worst’ residual capacity is taken to be the ‘best’ or ‘optimum’ channel selection were terminal device r selected to be the access point at S619. Information identifying the ‘best’ or ‘optimum’ channel selection were terminal device r selected to be the access point at S619 (and the associated residual capacity information) is stored appropriately.

The constant r is then incremented and, if the total number of candidate terminal devices, N, has not been reached (at S623) the loop from S605 to S621 is repeated and hence the respective ‘best’ channel selection is identified for each terminal device when taken to be the access point.

When the total number of terminal devices, N, has been reached at S623, the WLAN manager 14 identifies (at S625) from the ‘best’ channel selections identified at S619, the terminal device which, were it to be selected as the access point, exhibits the highest residual capacity in the ‘best’ channel identified for that terminal device at S619. Information identifying the terminal device which, were it to be selected as the access point, exhibits the highest residual capacity is stored in association with information identifying the corresponding ‘best’ channel (and the associated residual capacity information). The terminal device which, were it to be selected as the access point, exhibits the highest residual capacity and the corresponding ‘best’ channel is considered to be the ‘best’ or ‘optimum’ access point/channel combination (referred to as the ‘best couple’).

The WLAN manager 14 checks, at S627, if the residual capacity for the ‘best’ or ‘optimum’ access point/channel combination and corresponding communication link (i.e. the communication link identified to be the ‘worst’ communication link) is positive. If the residual capacity is found to be positive then the current value of Pᵢ is taken to be the minimum transmission power required to achieve the required quality of service at S631. Otherwise, if the residual capacity is found to be negative, the value of Pᵢ is increased by a predetermined amount a, and the resulting residual capacity for the ‘best’ or ‘optimum’ access point/channel combination and corresponding communication link recalculated and its polarity checked at S627. This process of checking the polarity of the residual capacity (S627), and increasing the transmit power by a (S629), is repeated until a positive residual capacity is reached or the value of Pᵢ reaches a maximum allowed value.

Accordingly, in this way the optimum access point/communication channel combination and the minimum transmitter power required to achieve sufficient quality of service are selected in a relatively efficient manner before the WLAN is set up.

Once the selection process is completed, the WLAN manager 14 assigns the role of the access point to the terminal device selected to be the access point (and/or assigns the role of ‘STA’ or ‘STAtion’ to the unselected terminal devices) before triggering operation of the WLAN on the communication channel selected for the purposes. The triggering is done using appropriate signalling, using the E-UTRAN network, via the base station 5. After this WLAN network is formed, the candidate stations (terminal devices) will then start communicating through the access point and the channel proposed by the WLAN manager. Accordingly, the WLAN network 12 is formed with a help of another system or technology (in this example E-UTRAN/LTE) without prior communication between the terminal device designated an ‘access point’ and the terminal devices designated ‘stations’ in order to perform direct measurements of transmitted signal quality (e.g. received signal power, interference, bit error rate (BER), lost packets, etc.).

### (Operation—Second Example)

Operation of the WLAN manager 14, to select the optimum access point and optimum channel will now be further described with reference to FIG. 7 which shows a simplified flow chart showing the steps followed by the WLAN manager 14.

Before the selection process shown in FIG. 7 begins, the WLAN manager 14 obtains the SNRreq (the required Signal-to-Noise Ratio) for the communication links (terminal device to terminal device) between the various terminal devices 3 that will ultimately make up the WLAN. The WLAN manager 14 also obtains an indication of where the terminal devices are located geographically from the E-SMLC 10 via the MME 9 using the E-UTRAN network. Further, the WLAN manager 14 retrieves measurements of interference and noise from the terminals (e.g. via the other entities in the E-UTRAN network), and information identifying the terminal device's Tx power. The WLAN manager 14 also obtains an indication of the type of environment (e.g. indoor/outdoor) that the terminal devices are located in and the respective path loss characteristics.

The selection process starts at S701 by initialising the WLAN manager 14 for finding any suitable AP/channel pairs. The candidate terminal devices 3 are each numbered with a unique index number which, in this embodiment, ranges from 1 through to ‘N’ (the total number of candidate terminal devices). After initialising a constant (in FIG. 7 shown as ‘r’) to 1 (at S703), the terminal device having index r is taken to be the access point at S705.

Each communication channel, which may be used by the terminal device that is being treated by the access point is numbered with a unique index number which, in this embodiment, ranges from 1 through to ‘M’ (the total number of communication channels for the device). After initialising a further constant (in FIG. 7 shown as ‘q’) to 1 (at S707), the communication channel having index q is taken to be the channel for which the current processing round is applicable, at S709.

The WLAN manager 14 then initialises, at S711, a set of candidate links with all the uplinks to and downlinks from the terminal device r that is taken to be the access point (and for the current channel q). The WLAN manager 14 randomly choses, at S713, a link within the set of candidate links to/from the terminal device r that is taken to be the access point, for the channel q.

The WLAN manager 14 then checks, at S715, if the per-link PER is achievable. If the per-link PER is found to be achievable for a particular link then the WLAN manager 14 discards, at S727, that link from the set of candidate links. Next, the WLAN manager 14 checks, at S729, if there are any further candidate links in the set. If the WLAN manager 14 finds that the set of candidate links is empty, it proceeds to step S731, in which it returns the current configuration of terminal device r that is currently being treated as the access point and the current channel q as a candidate configuration to reach all per-link PER requirements. Otherwise, if the set of candidate links is found not empty, the WLAN manager 14 returns to step S713 and randomly selects the next link within the set of candidate links and performs the checking again at step S715.

If at S715 the WLAN manager 14 finds that the per-link PER is not achievable for any one link, then the constant q is incremented, at S717, and, if the total number of channels, M, has not been reached (at S719) the loop from S709 to S717 is repeated. Hence, per-link PER is checked for each communication link of a particular communication channel of the terminal device r being treated as the access point until a link that does not meet the per-link PER requirements is found. If a link that does not meet the per-link PER requirements is found then the process moves on to the next channel (if available).

When all channels have been checked for a particular terminal device (the total number of channels, M, has been reached at S719), the constant r is incremented (at S721). If the total number of candidate terminal devices, N, has not been reached (at S723) then the loop from S705 to S721 is repeated and hence the per-link PER is checked for the next terminal device to be taken as the access point.

When all terminal devices have been checked (the total number of terminal devices, N, has been reached at S723), the WLAN manager 14 returns (at S725) a result indicating that there is no compliant AP/channel pair that allows the per-link PER requirements to be reached for every link of that AP/channel pair.

Accordingly, in this way the optimum access point/communication channel combination to achieve sufficient quality of service are selected in a relatively efficient manner before the WLAN is set up.

Advantages provided by the AP/channel pair selection method shown in FIG. 7 include:
by considering individual links, it is ensured that QoS will be met on a per-link basis;
compatibility with the largely dominant Wi-Fi version IEEE 802.11b (which does not provide means for transmission power adaptation) is ensured;
compatibility with largely dominant smartphone operating systems, which do not offer a way to set the Wi-Fi transmission power, is ensured;
the AP/channel pair selection process allows (i) identification of at least one AP among all terminal devices, and (ii) selection of at least one channel which allows per-link PER requirements to be met for every link of that channel.

Once the selection process is completed, the WLAN manager 14 assigns the role of the access point to the terminal device selected to be the access point (and/or assigns the role of ‘STA’ or ‘STAtion’ to the unselected terminal devices) before triggering operation of the WLAN on the communication channel selected for the purposes. The triggering is done using appropriate signalling, using the E-UTRAN network, via the base station 5. After this WLAN network is formed, the candidate stations (terminal devices) will then start communicating through the access point and the channel proposed by the WLAN manager. Accordingly, the WLAN network 12 is formed with a help of another system or technology (in this example E-UTRAN/LTE) without prior communication between the terminal device designated an ‘access point’ and the terminal devices designated ‘stations’ in order to perform direct measurements of transmitted signal quality (e.g. received signal power, interference, bit error rate (BER), lost packets, etc.).

(Operation—third example)

Operation of the WLAN manager 14, to select the optimum access point and optimum channel will now be further described with reference to FIG. 8 which shows a simplified flow chart showing the steps followed by the WLAN manager 14.

Before the selection process shown in FIG. 8 begins, the WLAN manager 14 obtains the SNRreq (the required Signal-to-Noise Ratio) for the communication links (terminal device to terminal device) between the various terminal devices 3 that will ultimately make up the WLAN. The WLAN manager 14 also obtains an indication of where the terminal devices are located geographically from the E-SMLC 10 via the MME 9 using the E-UTRAN network. Further, the WLAN manager 14 retrieves measurements of interference and noise from the terminals (e.g. via the other entities in the E-UTRAN network). The WLAN manager 14 also obtains an indication of the type of environment (e.g. indoor/outdoor) that the terminal devices are located in and the respective path loss characteristics.

The selection process starts at S801 by initialising the WLAN manager 14 for finding any suitable AP/channel pairs. The candidate terminal devices 3 are each numbered with a unique index number which, in this embodiment, ranges from 1 through to ‘N’ (the total number of candidate terminal devices). After initialising a constant (in FIG. 8 shown as ‘k’) to 1 (at S803), the terminal device having index k is taken to be the access point at S805.

Each communication channel, which may be used by the terminal device that is being treated by the access point is numbered with a unique index number which, in this embodiment, ranges from 1 through to ‘M’ (the total number of communication channels for the device). After initialising a further constant (in FIG. 8 shown as ‘ch’) to 1 (at S807), the communication channel having index ch is taken to be the channel for which the current processing round is applicable, at S809.

The WLAN manager 14 then computes, at S811, P_{Tx,min}^{k,ch}(i,j,ch) (i.e. the minimum required mean transmission power for the AP/channel combination being considered) for every other terminal device to/from (i.e. uplink/downlink) the terminal device taken to be the access point in the current processing round.

In step S813, the WLAN manager 14 finds and stores MaxP_{Tx,min}^{k,ch} (i.e. the maximum of the minimum required mean transmission powers for the AP/channel combination being considered) from all the P_{Tx,min}^{k,ch}(i,j,ch) where the terminal device having index k is taken to be the access point, the channel having index ch is taken to be the operating channel.

Next, in step S817, the constant ch is incremented and, if the total number of channels, M, has not been reached (at S819) the loop from S809 to S817 is repeated for the next channel of the terminal device currently taken to be the access point.

When all channels have been checked for a particular terminal device (the total number of channels, M, has been reached at S819), the WLAN manager 14 determines the minimum power MinMaxP_{Tx,min}^{k,Ch}^{ₒₚₜ}^{(k)} from all the values of MaxP_{Tx,min}^{k,ch} for all the channels of the terminal device k currently taken to be the access point. The WLAN manager 14 then stores the corresponding channel Chₒₚₜ(k) as the best channel for the terminal device k currently taken to be the access point.

Next, in step S821, the constant k is incremented. If the total number of candidate terminal devices, N, has not been reached (at S823) then the loop from S805 to S821 is repeated and hence the minimum required mean transmission powers for each AP/channel combination are computed and checked for their potential use for configuring a WLAN.

When all terminal devices have been checked (the total number of terminal devices, N, has been reached at S823), the WLAN manager 14 finds (at S825) the minimum transmission power MinMinMaxP_{Tx,min}^{k}^{ₒₚₜ}^{,Ch}^{ₒₚₜ}^{(k}^{ₒₚₜ}⁾ from all the MinMaxP_{Tx,min}^{k,Ch}^{ₒₚₜ}^{(k)} considered at S820. The WLAN manager 14 then stores the corresponding access point ‘kₒₚₜ’ and channel ‘Chₒₚₜ(kₒₚₜ)’ combination as the most power efficient AP/channel combination. The WLAN manager 14 also returns, for each terminal device, the minimum uplink/downlink transmit powers (‘P_{Tx,min}’) required to communicate via the selected access point (i.e. in the WLAN to be formed) using the selected channel.

The values of the initial transmit powers (e.g. a ‘TxPwr’ parameter) may be signalled to the stations, or alternatively, the transmit powers may be autonomously managed by the stations themselves during operation (e.g. to ensure that the stations meet their respective QoS requirements).

Accordingly, in this way the optimum access point/communication channel combination to achieve sufficient quality of service and with the minimum required transmission powers are selected before the WLAN is set up.

Once the selection process is completed, the WLAN manager 14 assigns the role of the access point to the terminal device selected to be the access point (and/or assigns the role of ‘STA’ or ‘STAtion’ to the unselected terminal devices) before triggering operation of the WLAN on the communication channel selected for the purposes. The triggering is done using appropriate signalling, using the E-UTRAN network, via the base station 5. After this WLAN network is formed, the candidate stations (terminal devices) will then start communicating through the access point and the channel proposed by the WLAN manager. Accordingly, the WLAN network 12 is formed with a help of another system or technology (in this example E-UTRAN/LTE) without prior communication between the terminal device designated an ‘access point’ and the terminal devices designated ‘stations’ in order to perform direct measurements of transmitted signal quality (e.g. received signal power, interference, bit error rate (BER), lost packets, etc.).

### (Signalling WLAN Configuration to Terminal Devices)

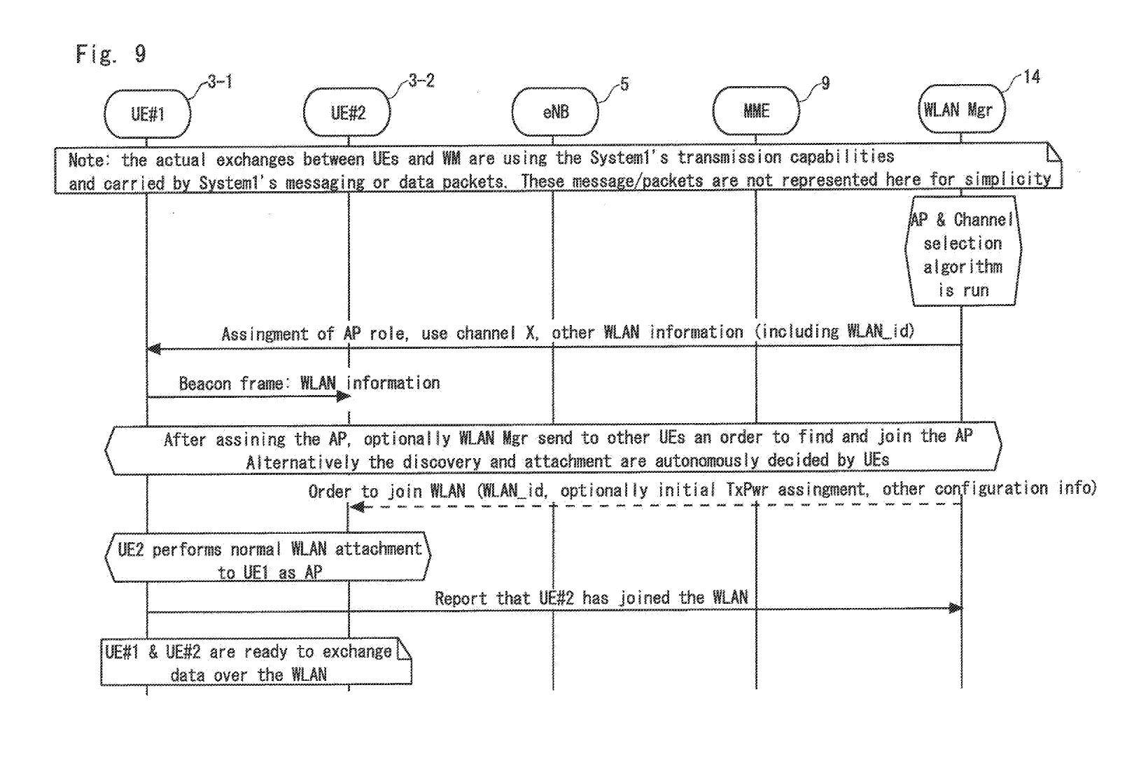

Exemplary operation to configure the WLAN will now be described in more detail with reference to FIG. 9 which shows a simplified timing diagram illustrating the steps taken by key components of the system of FIG. 1.

As seen in FIG. 9, initially messages are exchanged between the WLAN manager (WLAN Mgr, WM) 14 and the terminal devices 3 (typically via the base station 5 and/or MME 9), using the resources of the cellular (E-UTRA) communications network (referred to as ‘system 1’ in FIG. 9), in order to provide the WLAN manager 14 with the information required to determine the simplified, target and residual capacities and/or a suitable AP/channel combination meeting all the per-link PER requirements for the various communications channels of the communication links between the different terminal devices.

One of the selection algorithms described above (or possibly a hybrid selection algorithm based on them) is then performed by the WLAN manager 14. In the example of FIG. 9, once the optimum access point and communication channel has been selected, the WLAN manager 14 signals the terminal device 3 that has been selected to operate as the access point (‘UE#1’ in the FIG. 9) with an indication that it has been selected as an access point (‘assignment of AP role’), information identifying the communication channel to use in the WLAN (‘use channel X’) and other WLAN configuration information required to configure the WLAN (‘other WLAN information’) including information for identifying the WLAN (‘WLAN id’). In this example, the terminal device 3 selected to be the access point sends a beacon frame, comprising the WLAN configuration information, to each of the other terminal devices 3 (only one (‘UE#2’) is shown) of the WLAN being configured including the WLAN id. Optionally, the WLAN manager 14 sends at least one message to each of the other terminal devices 3, of the WLAN being configured, requesting the terminal device 3 to join the WLAN identified by the WLAN id. In this case, if a required minimum transmit power has been calculated, the WLAN manager 14 may also include in the sent message(s) the initially required transmit power value (TxPwr) for each terminal device. Alternatively, the terminal devices 3 may discover and join the newly formed WLAN autonomously. Each of the terminal devices 3 being so configured (and/or terminal devices that have autonomously discovered) the WLAN then performs a WLAN attachment procedure to join the WLAN identified by the WLAN id using the terminal device 3 selected to be the access point, as the access point. On successful attachment of each non-access point terminal device 3, the terminal device 3 selected to be the access point reports, to the WLAN manager 14, the attachment of that non-access point terminal device 3 as a station (STA) of the WLAN. After a non-access point terminal device 3 as a station (STA) of the WLAN has successfully joined the WLAN, the newly joined station can communicate with the access point terminal device 3, and hence with other stations of the WLAN via the access point terminal device 3.

### (Modifications and Alternatives)

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the WLAN manager and S1-WLAN and SW interfaces are new and are not described as part of the current 3GPP architecture. These features could be implemented as part of an existing 3GPP entity and/or interface. Further, an entity/interface providing a similar function may be called something other than the ‘WLAN manager’ and ‘S1-WLAN’ and ‘SW’ interfaces.

It will further be appreciated that the HSS is necessary only if the terminal capabilities are stored in HSS. Whilst such terminal capabilities may be stored in the HSS, terminal capabilities may alternatively (or additionally) be stored in the WLAN manager.

In the above embodiment, two terminal devices were allowed to establish a local area network based D2D connection with each other via an access point. As those skilled in the art will appreciate whilst one of the terminal devices 3 can be configured to act as an access point as described the potential access points could include one or more dedicated access points. In this case the access point for the WLAN could still be selected, based on a calculation of simplified capacity as described above, albeit from a candidate set including one or more dedicated access points and terminal devices that could act as an access point.

It will be appreciated that, depending on the WLAN technology, the access point can have different names: for example, it can be named access point in 802.11 technologies, Master in Bluetooth technologies, and possibly named differently in other WLAN technologies.

Although, in FIG. 9, a specific message sequence represented by individual arrows is shown, it will be appreciated that each arrow may represent the exchange of a plurality of messages for achieving the objective indicated by the arrow.

In the above embodiments, the terminal device received the WLAN configuration information from a core network entity, e.g. the mobility management entity, via an E-UTRAN base station (eNB). It will be appreciated that the terminal device might receive the WLAN control information via any base station operating according to a different standard, such as GSM, WCDMA, CDMA2000, LTE, LTE-A. Such base stations can be referred to as BS, BTS, NodeB, etc. Alternatively, the WLAN configuration information might be received from the base station indirectly, e.g. using a relay node (RN) or a donor base station (DeNB).

In the above embodiments, the term access point has been used for illustrative purposes only and in no way shall be considered limiting the invention to any particular standard. Embodiments of the invention are applicable to systems using any type of node for accessing a local area network irrespective of the access technology used thereon. In the above embodiments, WLAN has been used as an example non-3GPP radio access technology. However, any access technologies covered in the 3GPP TS 23.402 standard, thus any other radio access technology (e.g. WiFi, WiMAX) or any wired or wireless communications technology (e.g. LAN, Bluetooth) can be used for creating a direct link between the two (or more) terminal devices in accordance with the above embodiments. The above embodiments are applicable to non-mobile or generally stationary user equipment as well.

Localisation information may be provided to the base stations by a node in or connected to the core network or by the terminal devices themselves using for example location services as described in 3GPP TS 23.271. The localisation information might comprise the provision of an identification of an available access point or the name of a WLAN network that the terminal device can access. A WLAN network might comprise of a number of associated access points selected in a similar manner to that described above.

In the above description of the first example, the terminal device selected to be the access point was the terminal device for which the residual capacity of the best communication channel of the worst identified communication link was maximised. In other words the access point and channel were selected to maximise the quality of service of the communication link exhibiting the worst predicted quality of service. It will be appreciated, however, that the communication channel and the access point could potentially be selected to maximise the quality of service provided by the terminal device exhibiting the worst predicted quality of service. Moreover, the communication channel and the access point could potentially be selected in order to maximise the quality of service provided by the terminal device exhibiting the best, rather than the worst, predicted quality of service.

In the above description of the second example, the terminal device selected to be the access point and the channel to be used for communication with the other terminal device are selected so as to meet all per-link PER requirements. It will be appreciated, however, that the communication channel and the access point could potentially be selected to meet a given global Quality of Service requirement of the WLAN to be formed. Further, it will also be appreciated that if the access point/channel selection according to the second example is unable to determine any AP/channel combination meeting all per-link PER requirements, then an alternative selection method (e.g. a method based on simplified capacity calculation or minimum transmission power calculations) might be used as a fall-back option. In other words, when the process shown in FIG. 7 terminates at step S725, the process might re-start at step s601 of FIG. 6 or at step S801 of FIG. 8.

In the second example, FIG. 7 shows the method stopping when the first terminal/channel pair meeting the requirements is found. However, it will be appreciated that the process may be continued to find a set of (or all) qualifying terminal/channel pairs from which one pair is selected (e.g. the best or most optimum AP/channel pair, depending on a given criterion).

In another embodiment, the communication channel and the access point could potentially be selected to improve global communications by selecting the communication channel and the access point that maximises the sum of residual capacities for all communication links.

In yet another embodiment, the communication channel and the access point could potentially be selected to improve global communications ‘fairness’ by selecting the communication channel and the access point that results in a similar residual capacity for each communication link as possible (for example, based on minimising the standard deviation of the residual capacities or using another statistical technique). Alternatively, global communications ‘fairness’ might also be improved by selecting the communication channel and the access point that results in a similar Quality of Service for each communication link as possible (for example, based on minimising the standard deviation of the Quality of Service or using another statistical technique).

In the third example, the communication channel and the access point are selected to minimise the maximum transmission power required to meet all the per-link PER requirements. However, it will be appreciated that the communication channel and the access point could potentially be selected to minimise the sum of transmission powers of all the links.

The term G_{i,j} is described to represent the antenna gain accounting for the antenna gain of both the transmitter and the receiver terminal device. It will be appreciated, however, that G_{i,j} may also include channel mean gain, if known, between the transmitter and the receiver terminal devices.

In the above examples, the term Hi,j is described to represent the mean gain of the communication channel between transmitter i and receiver j. However, it will be appreciated that the use of Hi,j in the calculations is optional, or in case Hi,j is not known, its value might be chosen to be 1.

In the above embodiments, the terminal devices are shown as cellular telephones. It will be appreciated, however, that the above embodiments could be implemented using terminal devices other than mobile telephones such as, for example, personal digital assistants, laptop computers, web browsers, etc.

Although as described above the WLAN manager generates the WLAN configuration information, this information may be generated by another network device, such as the home subscriber server or the mobility management entity. The WLAN manager thus may be implemented either as a standalone unit or may be implemented as part of the mobility management entity, as part of the base station, or as part of the home subscriber server or any other network entity connected to the core network. The WLAN manager can be shared by multiple core networks.

In the above description, the WLAN manager 14, the mobility management entity 9, the base station 5, and the terminal devices 3 are described for ease of understanding as having a number of discrete functional components or modules. Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the WLAN manager, to the mobility management entity, to the base station or to the terminal device as a signal over a computer network, or on a recording medium. Further, the functionality performed by part or all of this software may be performed using one or more dedicated hardware circuits. However, the use of software modules is preferred as it facilitates the updating of the WLAN manager 14, the mobility management entity 9, the base station 5 and the terminal devices 3 in order to update their functionalities.

Various other modifications will be apparent to those skilled in the art and will not be described in further detail here.

For example, the present invention can be materialized by a program for causing a computer such as a CPU (Central Processing Unit) to execute the processes shown in FIGS. 6 to 9.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM, CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

This application is based upon and claims the benefit of priorities from United Kingdom Patent Application No. 1209953.7, filed on Jun. 6, 2012, United Kingdom Patent Application No. 1220696.7, filed on Nov. 16, 2012, and United Kingdom Patent Application No. 1220697.5, filed on Nov. 16, 2012, the disclosure of which are incorporated herein in their entirety by reference.

### REFERENCE SIGNS LIST

1 TELECOMMUNICATIONS NETWORK
3 (3-1, 3-2, 3-3, 3-4) MOBILE TERMINAL DEVICE
5 BASE STATION
7 CORE NETWORK
9 MME
10 E-SMLC
12 WLAN
13 EXTERNAL IP NETWORK
14 WLAN MANAGER
15 HSS
16 S-GW
17 P-GW
201 TRANSCEIVER CIRCUIT
203 MME INTERFACE
205 HSS INTERFACE
207 CONTROLLER
209 MEMORY
211 OPERATING SYSTEM
213 COMMUNICATIONS CONTROL MODULE
215 WLAN MANAGEMENT MODULE
217 WLAN DATABASE
219 QUALITY PARAMETER DETERMINATION MODULE
301 TRANSCEIVER CIRCUIT
303 BASE STATION INTERFACE
305 HSS INTERFACE
306 WLAN MANAGER INTERFACE
307 CONTROLLER
308 E-SMLC INTERFACE
309 MEMORY
313 COMMUNICATIONS CONTROL MODULE
315 LOCALISATION INFORMATION MODULE
319 WLAN COMMUNICATION MODULE
401 TRANSCEIVER CIRCUIT
403 ANTENNA
405 MME INTERFACE
406 GATEWAY INTERFACE
407 CONTROLLER
409 MEMORY
411 OPERATING SYSTEM
413 COMMUNICATIONS CONTROL MODULE
415 RRC MODULE
501 TRANSCEIVER CIRCUIT
503 ANTENNA
505 USER INTERFACE
507 CONTROLLER
509 MEMORY
511 OPERATING SYSTEM
513 COMMUNICATIONS CONTROL MODULE
515 RRC MODULE
517 WLAN MODULE
518 WLAN CLIENT

1. A communication entity for a communication system in which terminal devices communicate with one another via a base station using a radio access technology, the communication entity comprising:
an identifying unit that identifies a plurality of said terminal devices for forming a potential local area network (LAN) of said terminal devices;
a determining unit that determines, for each terminal device of said plurality of terminal devices, a respective characteristic value associated with communicating using at least one communication channel in at least one communication link between each said terminal device and each other of said plurality of terminal devices, wherein said characteristic value is representative of a potential quality of service that will be provided by the at least one communication channel as part of said potential LAN;
a selecting unit that selects a terminal device to operate as an access node of said local area network based on said characteristic values so determined; and
a communicating unit that communicates with at least one of said plurality of terminal devices to identify which of said plurality of terminal devices has been selected to operate as an access node and/or which of said plurality of terminal devices has not been selected to operate as an access node.

2. The communication entity as claimed in claim 1 wherein there are a plurality of potential communication channels for communicating in the at least one communication link between each said terminal device and each other of said plurality of terminal devices; wherein said selecting unit is operable to select a communication channel to use for communication in said LAN based on said at least one characteristic value determined by said determining unit; and wherein said communicating unit is operable to communicate with at least one of said plurality of communication devices to identify said selected communication channel.

3. The communication entity as claimed in claim 2 wherein said selecting unit is operable:
to identify, for each of said plurality of terminal devices, a respective lowest quality communication link, between that terminal device and each other of said plurality of terminal devices, wherein the lowest quality link exhibits the lowest determined characteristic value from amongst the characteristic values determined for all the communication channels on all the communication links for that terminal; and
to select a terminal device to operate as an access node and/or a communication channel to use for communication in said LAN so as to maximise the potential quality of service for communications using said lowest quality communication link.

4. The communication entity as claimed in claim 2 wherein said selecting unit is operable:
to identify, for each of said plurality of terminal devices, a respective lowest quality communication link, between said terminal device and each other of said plurality of terminal devices, wherein the lowest quality link exhibits the lowest determined characteristic value from amongst the characteristic values determined for all the communication channels on all the communication links for that terminal; and
to select a terminal device to operate as an access node and/or a communication channel to use for communication in said LAN based on the lowest quality communication links so identified.

5. The communication entity as claimed in claim 4 wherein said selecting unit is operable:
to identify, for each of said plurality of terminal devices, a communication channel exhibiting the highest determined characteristic value from amongst the communication channels on the lowest quality communication link identified for that terminal device; and
to select a terminal device to operate as an access node and/or a communication channel to use for communication in said LAN based on said communication channels, from amongst the communication channels on the lowest quality communication links, found to exhibit the highest determined characteristic values.

6. The communication entity as claimed in claim 5 wherein said selecting unit is operable:
to identify, from amongst said communication channels found to exhibit the highest determined characteristic values for the lowest quality communication links, the communication channel having the highest overall determined characteristic value;
to select, as the terminal device to operate as an access node in said LAN, the terminal device associated with communication channel having the highest overall determined characteristic value; and/or
to select, as the communication channel to use for communication in said LAN, the communication channel having the highest overall determined characteristic value.

7. The communication entity as claimed in claim 2 wherein said selecting unit is operable to:
identify, based on said determined characteristic values, a lowest communication quality terminal device, wherein the lowest communication quality terminal device exhibits the lowest characteristic value from amongst the characteristic values determined for the communication channels and the communication links for the plurality of terminal devices; and
to select a terminal device to operate as an access node and/or a communication channel to use for communication in said LAN so as to maximise the potential quality of service, for communications with said lowest communication quality terminal device.

8. The communication entity as claimed in claim 2 wherein said selecting unit is operable to:
identify, based on said determined characteristic values, a highest communication quality terminal device, wherein the highest communication quality terminal device exhibits the highest characteristic value from amongst the characteristic values determined for the communication channels and the communication links for the plurality of terminal devices; and
to select a terminal device to operate as an access node and/or a communication channel to use for communication in said LAN so as to maximise the potential quality of service for communications with said highest communication quality terminal device.

9. The communication entity as claimed in claim 2 wherein said selecting unit is operable to select a terminal device to operate as an access node and/or a communication channel to use for communication in said LAN so as to maximise the sum of said characteristic values for all said communication links between each said terminal device and each other of said plurality of terminal devices.

10. The communication entity as claimed in claim 2 wherein said selecting unit is operable to select a terminal device to operate as an access node and/or a communication channel to use for communication in said LAN so as to minimise the communication link to communication link variation in characteristic values for said communication links between each said terminal device and each other of said plurality of terminal devices.

11. The communication entity as claimed in claim 1 wherein said selecting unit is operable to determine said characteristic value based on at least one equation or algorithm represented in memory of said entity.

12. The communication entity as claimed in claim 11 wherein said selecting unit is operable to determine said characteristic value based on the following equation:
$$C ( i , j , ch ) = {log}_{2} ( 1 + \frac{{P}_{i} {d}_{i , j}^{- α} {G}_{i , j}}{{I}_{j , ch} + {n}_{j , ch}} ) , for i , j = 1 , … , N and ch = 1 , … , M \qquad [ Math . 28 ]$$
where:
C(i, j, ch) is an absolute characteristic value that is representative of the quality of service in a communication link from a terminal device indexed i, to a terminal device indexed j, in a channel indexed ch;
Pᵢ is a transmit power attributed to the terminal device i;
d_{i,j} is the distance between terminal device i and terminal device j;
α is an exponent to take account of path loss for the link between terminal device i and terminal device j;
G_{i,j} is a gain value based on the antenna gain of both terminal device i and terminal device j;
I_{j,ch} is a measure of the interference at the terminal device j in communication channel ch;
n_{j,ch} is a measure of the Guassian noise at the terminal device j in communication channel ch;
M is the number of channels;
N is the number of terminal devices in the potential LAN.

13. The communication entity as claimed in claim 12 wherein said characteristic value is said absolute characteristic value.

14. The communication entity as claimed in claim 12 wherein said selecting unit is operable to determine said characteristic value further based on the following equation:
Δ(_{i,j,ch})=C(i,j,ch)−C₀(j) [Math. 29]
where:
C(i, j, ch) is the absolute characteristic value that is representative of the quality of service in the communication link from the terminal device indexed i, to the terminal device indexed j, in the channel indexed ch;
Δ(_{i,j,ch}) is a relative characteristic value that is representative of the quality of service, relative to a target quality of service, for the communication link from the terminal device indexed i, to a terminal device indexed j, in a channel indexed ch; and
C₀(j) is a target characteristic value that is representative of a target quality of service in a communication link.

15. The communication entity as claimed in claim 14 wherein said characteristic value is said absolute characteristic value.

16. The communication entity as claimed in claim 1 wherein said determining unit is operable to determine said characteristic values based on a transmitter power; wherein said selecting unit is operable to check if the determined characteristic values indicate that the quality of service represented by the determined characteristic values meets a required quality of service; wherein if the quality of service represented by the determined characteristic values does not meet the required quality of service, said determining unit is operable to recalculate said characteristic values based on an increased transmitter power.

17. The communication entity as claimed in claim 16 wherein said recalculation of said characteristic values is repeated, based on increasing transmitter powers, until the quality of service represented by the determined characteristic values meets the required quality of service or a maximum transmitter power is reached.

18-26. (canceled)

27. A terminal device for a communication system in which terminal devices communicate with one another via a base station using a radio access technology, the terminal device comprising:
a receiving unit that receives, from a communication entity of the communication system, information identifying that said terminal device has been selected to operate as an access node of a local area network (LAN) of said terminal devices;
a communicating unit that communicates with the communication entity, and other terminal devices, to form a LAN of terminal devices in which said terminal device is the access node.

28. The terminal device as claimed in claim 27 further comprising a providing unit that provides the results of measurements, to the communication entity, wherein said results represent at least one of measured interference and measured noise in a communication channel on a communication link between the terminal device from which the measurement results are received and at least one other of said terminal devices, and wherein said information identifying that the terminal device has been selected to operate as an access node is provided by said communication entity based on said results of measurements.

29-31. (canceled)

32. A method performed by a terminal device of a communication system in which terminal devices communicate with one another via a base station using a radio access technology, the method comprising:
receiving, from a communication entity of the communication system, information identifying that the terminal device has been selected to operate as an access node of a local area network (LAN) of said terminal devices;
a communicating unit that communicates with the communication entity, and other terminal devices, to form a LAN of terminal devices in which said terminal device is the access node.

33-101. (canceled)
